(19) United States
(12) Patent Application Publication
(10) Pub. No.: US 2017/0300748 A1
(43) Pub. Date: Oct. 19, 2017

(54) SCREENPLAY CONTENT ANALYSIS ENGINE AND METHOD

(71) Applicant: SCRIPTHOP LLC, Portland, OR (US)

(72) Inventors: BRIAN AUSTIN, Portland, OR (US); SCOTT FOSTER, West Hollywood, CA (US)

(21) Appl. No.: 15/088,103

(22) Filed: Mar. 31, 2016

Related U.S. Application Data
(60) Provisional application No. 62/142,413, filed on Apr. 2, 2015.

(51) Int. Cl. G06K 9/00; G06F 17/27

(52) U.S. Cl. CPC G06K 9/00469; G06F 17/2705; G06F 17/2785

(57) ABSTRACT

Embodiments of the inventive concept provide a screenplay content analysis engine and associated method for automatically analyzing a screenplay document. The screenplay content analysis engine can include logic sections for interpreting and analyzing the screenplay document. The logic sections can include a screenplay preconditioner logic section, an initial pass interpreter logic section, a second pass interpreter logic section, a deep interpreter logic section, and a screenplay analysis logic section. The method can include preconditioning the screenplay document, performing an initial interpretive pass of nodes associated with the screenplay document, performing a second interpretive pass, performing a deep interpretive pass, performing a screenplay analysis based on the interpretive passes, and displaying summarized information about the screenplay document. The nodes associated with the screenplay document can include left position information, which are grouped together and compared with predefined left positions, so that the various body section types can be detected and stored.

### RELATED APPLICATION DATA

This application claims the benefit of common-owned U.S. Provisional Application Ser. No. 62/142,413, filed on Apr. 2, 2015, which is hereby incorporated by reference.

### TECHNICAL FIELD

This application pertains to interpretation and analysis of screenplays, and more particularly, to a screenplay content analysis engine and method for analyzing one or more screenplay documents.

### BACKGROUND

Screenplays, sometimes referred to as “scripts,” are a document format used to produce motion films (i.e., movies) and television shows. Screenplays are arguably the most crucial part of the entertainment industry's commerce. Prior to the existence and adoption of more personal electronic devices such as computer tablets, such screenplay documents were often printed out to physical paper, three hole punched, and held together by brads in the top and bottom holes. A screenplay is typically comprised of a title page, naming the title of the movie or television show along with the name of the writer or writers, followed by a somewhat-standardized format of screenplay information thereafter.

The standardized format is usually made up of different sections including “slug lines,” action/description sections, and dialogue sections. The slug lines are the headers of each scene, which include information, for example, on whether the particular scene is an interior scene “INT.” or exterior scene “EXT.” The slug lines may also describe where the scene is set and what approximate time the scene takes place, such as “DAY” or “NIGHT.” Below the slug lines are descriptive sections, often referred to as action or description sections. The action or description sections typically span from left margin to right margin. The action or description sections describe what it is happening on-screen. Centered in the page with tighter margins are the dialogue sections with the character name centered above what they are intended to say.

Screenplay formats can have added complexity such as dual dialogue sections, where two sections of dialogue appear horizontally next to each other when characters speak at the same time. Another commonly found section of text appears just under the character name, preceding their dialogue, which is referred to as parentheticals, which are intended to convey the manner in which the dialogue is meant to be conveyed. Less meaningful ancillary text is also found on a screenplay that can indicate revisions, camera direction, or when one section continues into another on the next page.

Without screenplays, movies, television shows, and even internet webisodes would not be possible. In Hollywood, talent agents, producers, managers, directors, casting directors, and the like, are all in the business of working with talent (such as actors and screenwriters) and interacting with each other. This complex interaction depends on their ability to quickly digest a staggering amount of screenplays, which average between about 90-120 pages for a movie and 24-75 pages for a television show. After reading—or just as often, skimming—a script, they must quickly make decisions as to whether a particular client (such as an “A-list” movie star) should take on a role, or whether a particular screenplay project is worth significant investment from a studio.

The recording, or logging, of basic screenplay information, and the deeper analysis or “coverage” of a screenplay, is conventionally left to an executive at a talent agency or production company to conduct entirely on their own. Coverage refers to the standardized note-taking, reporting, or reviewing format used by movie studios and agencies to summarize the story in a screenplay, and also to give feedback in the form of criticism. Coverage can be anywhere from a few pages to 6 or 7 pages of writing. It takes considerable human effort to assimilate a screenplay and perform the coverage needed to draw conclusions, which can have a big impact on whether the movie or show is eventually a success or not.

Accordingly, a need remains for improved methods and systems for interpreting and analyzing screenplays. Embodiments of the inventive concept address these and other limitations in the prior art.

### BRIEF DESCRIPTION OF THE DRAWINGS

FIG. 1A illustrates a block diagram including a screenplay document and a screenplay content analysis engine in accordance with embodiments of the inventive concept.

FIG. 1B illustrates a block diagram including additional details of various components of the screenplay content analysis engine in accordance with embodiments of the inventive concept.

FIGS. 2A and 2B are examples of body pages of a screenplay document in a structured format that is considered more or less industry standard.

FIGS. 3A and 3B include reference numeral indicators for various body sections within body pages of the screenplay document in the structured format.

FIG. 4 is an example of a screenplay title page of the screenplay document.

FIG. 5 identifies components of the title page of FIG. 4.

FIG. 6 illustrates a block diagram including an example of the user interface of the screenplay content analysis engine accessible via a display in accordance with embodiments of the inventive concept.

FIG. 7 illustrates a block diagram including another example of the user interface of the screenplay content analysis engine accessible via the display in accordance with embodiments of the inventive concept.

FIG. 8 illustrates a block diagram including yet another example of the user interface of the screenplay content analysis engine accessible via the display in accordance with embodiments of the inventive concept.

FIG. 9 illustrates a block diagram including still another example of the user interface of the screenplay content analysis engine accessible via the display in accordance with embodiments of the inventive concept.

FIG. 10 illustrates a block diagram including another example of the user interface of the screenplay content analysis engine accessible via the display in accordance with embodiments of the inventive concept.

FIG. 11 illustrates a block diagram including another example of the user interface of the screenplay content analysis engine accessible via the display in accordance with embodiments of the inventive concept.

FIGS. 12A and 12B show a flow diagram illustrating a technique for analyzing a screenplay document in accordance with embodiments of the inventive concept.

The foregoing and other features of the inventive concept will become more readily apparent from the following detailed description, which proceeds with reference to the accompanying drawings.

### DETAILED DESCRIPTION OF THE EMBODIMENTS

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first logic section could be termed a second logic section, and, similarly, a second logic section could be termed a first logic section, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### I. Import and Preconditioning of a Screenplay

A screenplay (i.e., script) document in electronic form can exist in various file formats, depending on the creation tool involved, whether specific to the originating creation tool or in an open format such as a PDF file format. The most popular format, due to the requirements of transmission, is the PDF format. However, it will be understood that the embodiments of the inventive concept disclosed herein are not limited by or exclusive to the PDF format. Any suitable document format including a screenplay can be interpreted, including textual information and information that is metadata in nature.

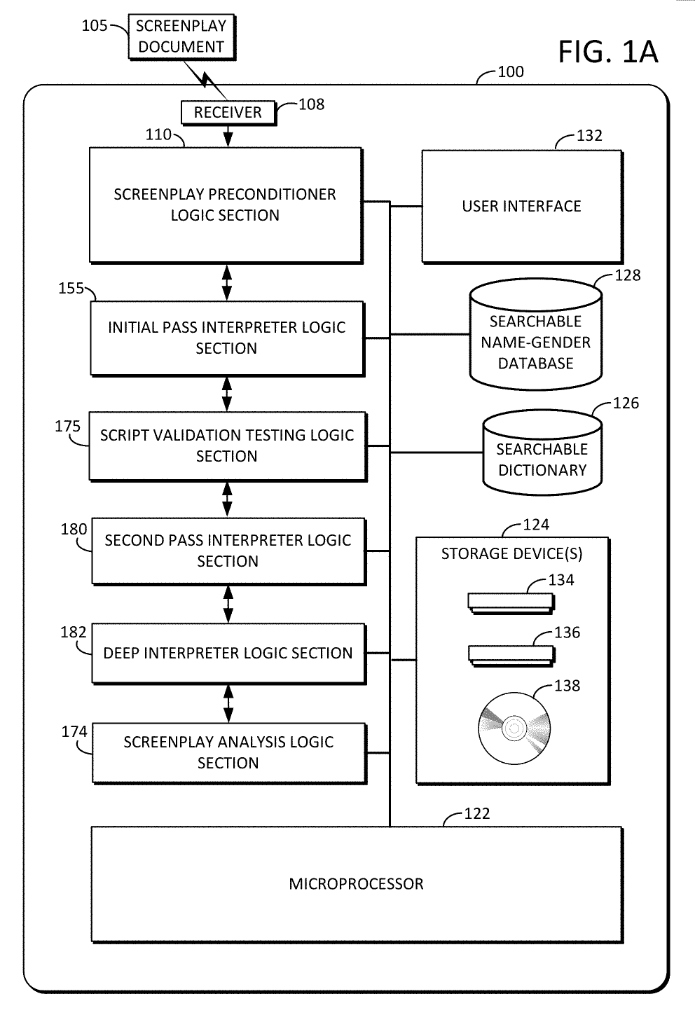

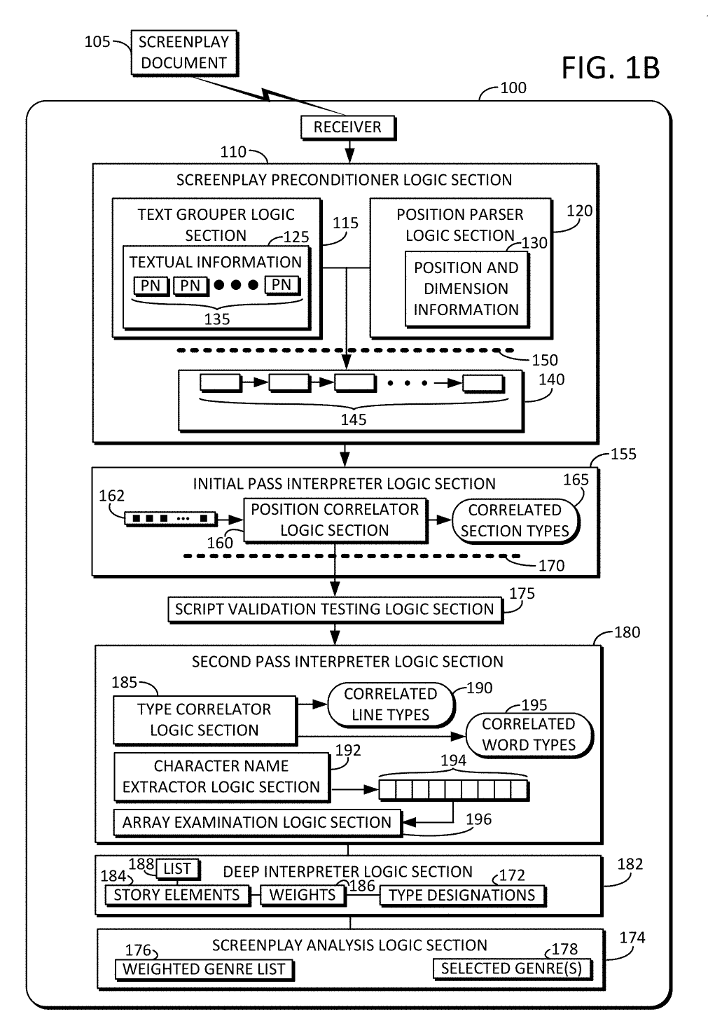

FIG. 1A illustrates a block diagram including a screenplay document 105 and a screenplay content analysis engine 100. FIG. 1B illustrates a block diagram including additional details of various components of the screenplay content analysis engine 100. Reference is now made to FIGS. 1A and 1B.

The screenplay document 105 can be received by a receiver 108 of the screenplay content analysis engine 100. For example, the screenplay content analysis engine 100 can receive the screenplay document 105 via a wired or wireless computer network such as the Internet, via a local network such as a local area network (LAN), or via a direct communication line, or the like. Prior to an analysis of the screenplay document 105, a screenplay preconditioner logic section 110 can interpret an electronic file format of the screenplay document 105. While the screenplay preconditioner logic section 110 is shown in FIGS. 1A and 1B as being part of the screenplay content analysis engine 100, it will be understood that in some embodiments the screenplay preconditioner logic section 110 can exist separate from the screenplay content analysis engine 100, which can receive and interpret the screenplay document 105, and then feed a preconditioned screenplay document 105 to the screenplay content analysis engine 100.

The screenplay content analysis engine 100 can include an initial pass interpreter logic section 155, a script validation testing logic section 175, a second pass interpreter logic section 180, a deep interpreter logic section 182, and/or a screenplay analysis logic section 174, as further described in detail below. In addition, the screenplay content analysis engine 100 can include a user interface 132, a searchable name-gender database 128, and/or a searchable dictionary 126, as also further described in detail below. In some embodiments, the searchable name-gender database 128 and/or the searchable dictionary 126 can be separate or remote from the screenplay content analysis engine 100, and accessible by the screenplay content analysis engine 100 over a network. The screenplay content analysis engine 100 can include one or more storage devices 124. The one or more storage devices 124 can include, for example, volatile memory 134 such as random access memory (RAM), nonvolatile memory 136 such as a flash drive, and/or a magnetic or optical storage medium 138 such as a hard disk drive.

Any one or more of the logic sections (e.g., 110, 155, 175, 180, 182, and 174) can store data in or on the one or more storage devices 124. The screenplay content analysis engine 100 can include a processor such as a microprocessor 122. The microprocessor 122 can be coupled to the logic sections (e.g., 110, 155, 175, 180, 182, and 174), the user interface 132, the searchable name-gender database 128, the searchable dictionary 126, and/or the one or more storage devices 124. The microprocessor 122 can process information associated with the components of the screenplay content analysis engine 100.

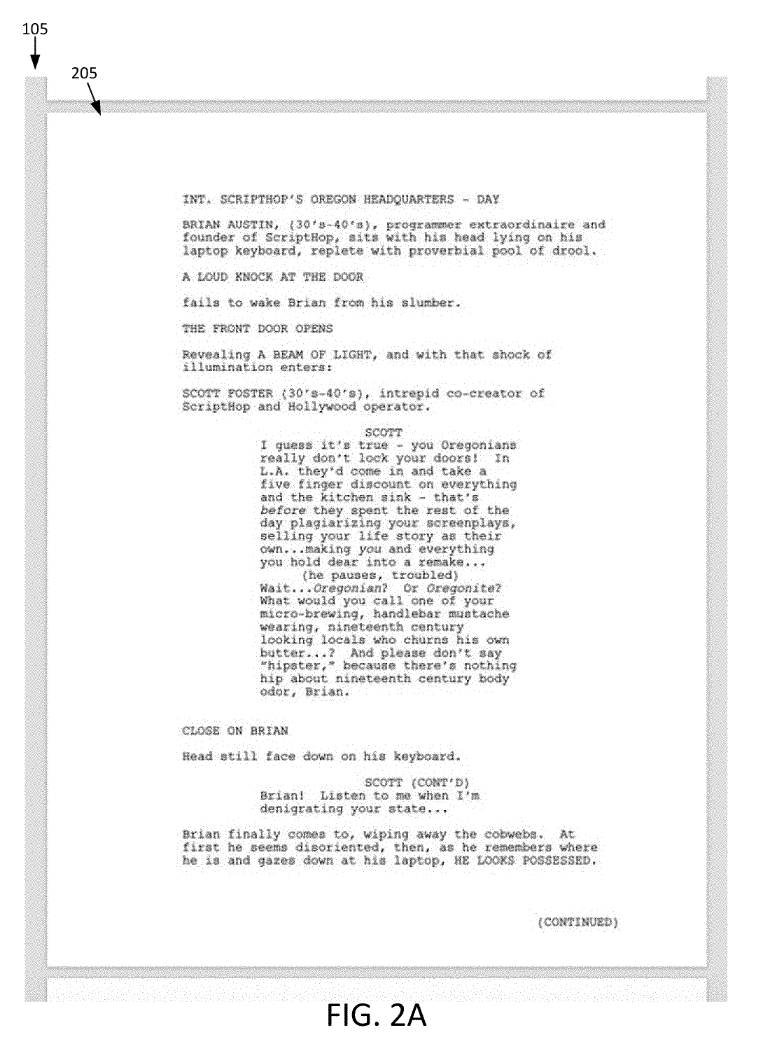

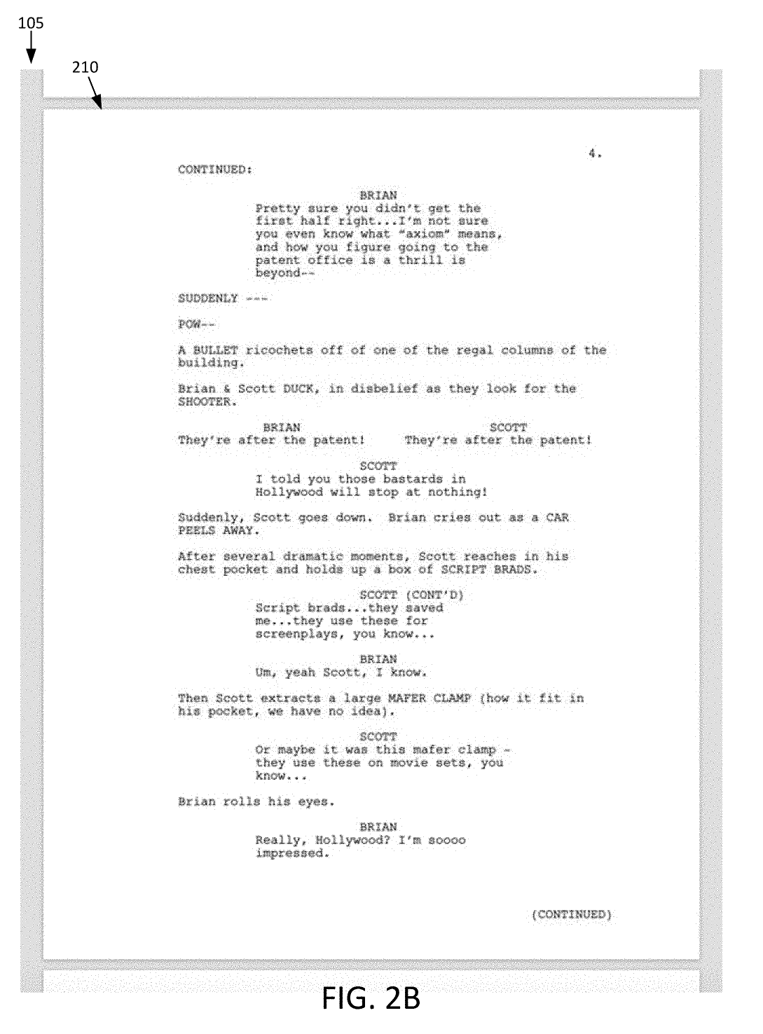

As shown in FIG. 2B, the screenplay preconditioner logic section 110 can include a text grouper logic section 115, which can extract and group textual information 125 within the screenplay document 105. The screenplay preconditioner logic section 110 can include a position parser logic section 120, which can determine position and dimension information 130 of the textual information 125 on each page of the screenplay document 105. The textual information 125, as referred to herein, is visible text on each page of the screenplay document 105.

The text grouper logic section 115 can pull the textual information 125 from the screenplay document 105, and organize the textual information into relational blocks 135. Each relational block 135 of the textual information 125 can include a grouping of text such as a line or paragraph. Each relational block 135 of text can include a corresponding page number PN identifying a logical page on which the relational block 135 of text appears. It will be understood that the page number PN can be metadata that is associated with each of the relational blocks 135. Each of the relational blocks 135 can have associated therewith the position and dimension information 130. For example, the position and dimension information 130 can include different position information such as “top,” “bottom,” “left,” or “right” for each of the relational blocks 135. In addition, the position and dimension information 130 can include size information such as width and height for each of the relational blocks 135.

The text grouper logic section 115 and the position parser logic section 120 can work in tandem to produce a list 140 of ordered screenplay evaluation nodes 145 based on the relational blocks 135 and the position and dimension information 130. A non-standard text filter logic section 150 can clean any non-standard text from the text of the relational blocks 135. The non-standard text can include, for example, text in a foreign language, ancillary text such as page numbers or “continued” indicators, illegible text, or the like. Each screenplay evaluation node 145 can include a corresponding relational block 135 and associated metadata for that node such as the page number PN and the position and dimension information 130. The screenplay evaluation nodes 145 can be produced for later in-depth evaluation and analysis of the screenplay, as further described in detail below.

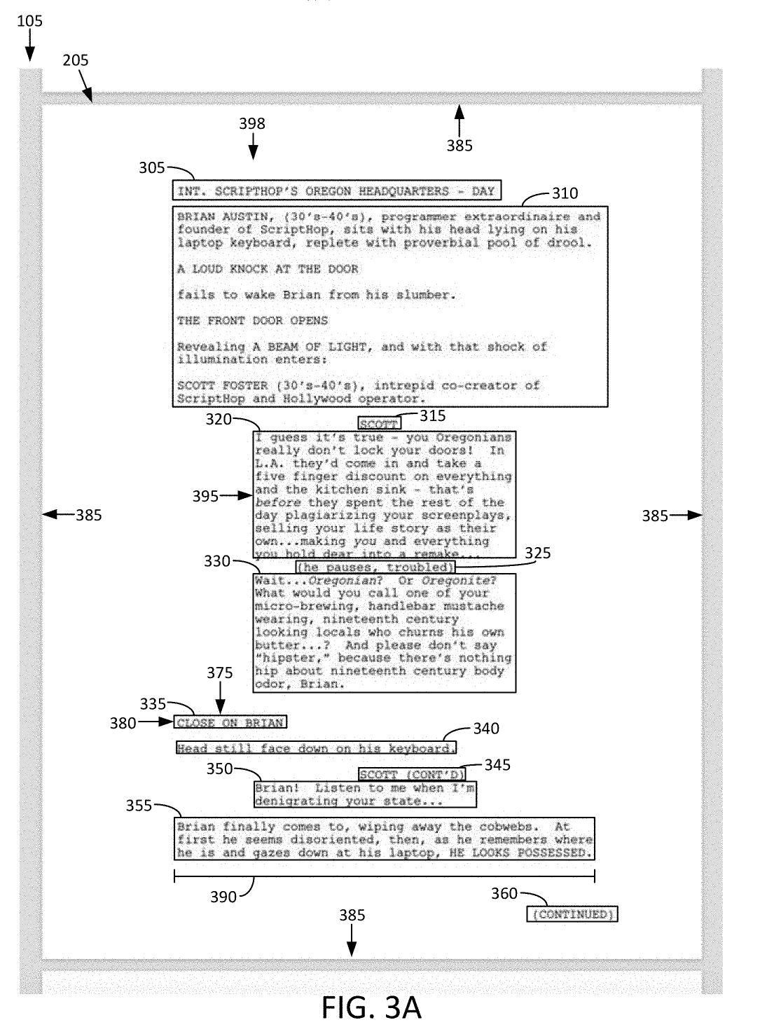

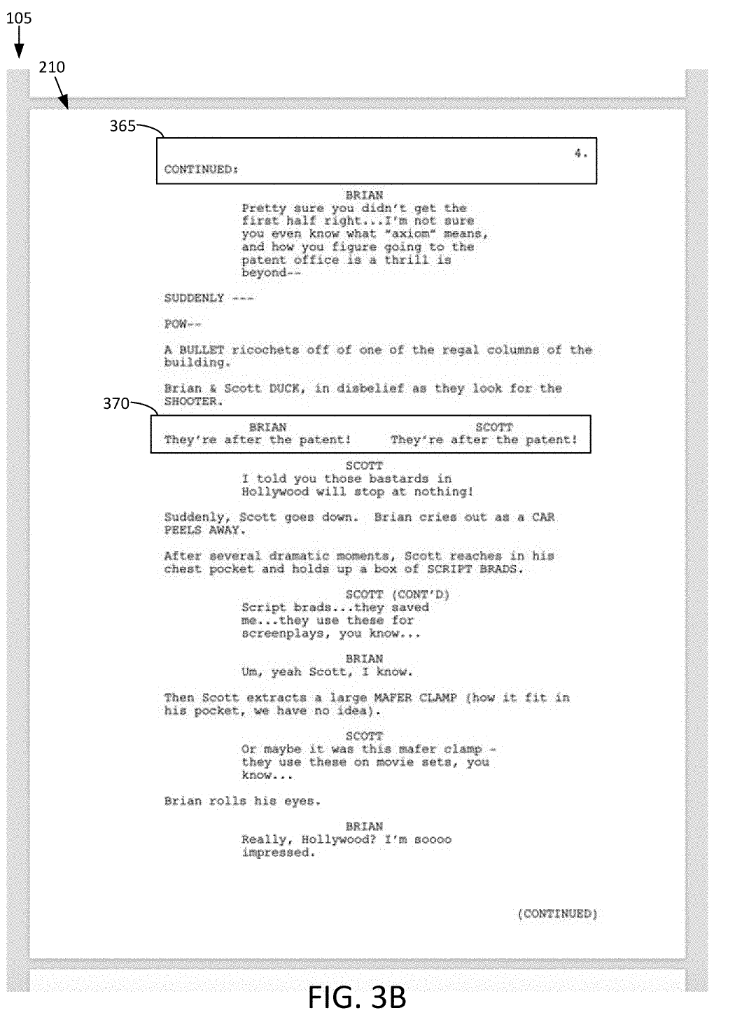

FIGS. 2A and 2B are examples of body pages (e.g., 205 and 210) of a screenplay document (e.g., 105) in a structured format that is considered more or less industry standard. There can be slight variances for margins when examining a library of screenplay documents. FIGS. 3A and 3B include reference numeral indicators for various body sections (e.g., 305, 310, 315, 320, 325, 330, 335, 340, 345, 350, 355, 360, 365, and 370) within body pages (e.g., 205 and 210) of the screenplay document 105 in the structured format. Reference is now made to FIGS. 1A, 1B, 2A, 2B, 3A, and 3B.

As shown in FIG. 3A, a body page 205 of the screenplay document 105 can include various body sections such as a slug line section 305, followed by an action or description section 310, followed by a character in dialogue section 315, followed by a dialogue section 320, followed by a parenthetical section 325, followed by another dialogue section 330, followed by a camera direction section 335, followed by another action or description section 340, followed by another character in dialogue section 345, followed by another dialogue section 350, followed by another action or description section 355, followed by an ancillary text section 360. As shown in FIG. 3B, a body page 210 of the screenplay document 105 can include additional body sections such as an ancillary text section 365 and a dual dialogue section 370, among others. It will be understood that the various body sections need not appear in the order illustrated in these examples, but can proceed in a different order and/or with different intervening body sections according to each unique screenplay.

Each body section has a top position and a left position relative to edge boundaries of the body page. For example, the camera direction section 335 has a top position 375 and a left position 380 relative to edge boundaries 385 of the body page 205. In addition, each body section has a particular width. For example, the action or description section 355 has a width 390. The position parser logic section 120 can determine at least one of the top or left positions of each body section, along with the width of each body section, and save such information as the position and dimension information 130. It will be understood that instead of top or left position information, right or bottom position information can be used without departing from the inventive concept disclosed herein. The screenplay content analysis engine 100 can use the position and dimension information 130 to interpret and analyze the content of the screenplay document 105, and to identify a type of each body section on each body page of the screenplay document 105, as further described below. The top and left positions (e.g., 375 and 380) also reveal the order of text associated with a particular page (e.g., 205) when interpreting and analyzing the screenplay document 105.

The text in the relational blocks 135 can be cleaned, by the non-standard text filter logic section 150, of any non-standard text that can occur in certain file formats of the screenplay document 105. The result of the import process is the ordered list 140 of screenplay evaluation nodes 145, ready to be further interpreted and analyzed.

### II. Interpretation of a Screenplay

Still referring to FIGS. 1A, 1B, 2A, 2B, 3A, and 3B, the screenplay content analysis engine 100 can include an initial pass interpreter logic section 155. The initial pass interpreter logic section 155 can build a most common left position list 162 of predefined common left positions based on an interpretation of one or more screenplay documents. In some embodiments, the most common left position list 162 of predefined common left positions can be manually set with well-known left positions. The initial pass interpreter logic section 155 can perform an initial interpretive pass of the list 140 of ordered screenplay evaluation nodes 145 to collect the left positions (e.g., 380) of all nodes associated with the screenplay document 105. The left positions associated with each of the nodes 145 can be sorted and grouped (i.e., by left position commonality), and then compared to the most common left position list 162 of predefined common left positions so that matches can be found.

The initial pass interpreter logic section 155 can include a position correlator logic section 160, which can compare the grouped left positions to the most common left position list 162 of predefined common left positions, and store the matched positions as correlated section types 165. The correlated section types 165 can be stored in or on a volatile memory 134, a non-volatile memory 136, and/or a magnetic or optical medium 138 of the one or more storage devices 124 of the screenplay content analysis engine 100. By way of an example, the character in dialogue sections (e.g., 315) are generally known to start near a center of the page. Accordingly, the initial pass interpreter logic section 155 can group the nodes 145 having what appear to be character in dialogue sections together into a same group based on similar left positions. The position correlator logic section 160 can correlate that group to a character in dialogue type from among the correlated section types 165. For example, the left position of a particular group that most closely correlates to a vertical reference line on a page (e.g., 205) that is associated with the character in dialogue type, can cause the position correlator logic section 160 to associate that particular group with the character in dialogue type, and store such association information as the correlated section types 165.

The most common left position that falls to the left of a vertical reference line associated with the character in dialogue type is likely to be a position associated with a dialogue type. The initial pass interpreter logic section 155 can group the nodes 145 having what appear to be dialogue sections together into a same group based on similar left positions. The position correlator logic section 160 can correlate that group to a dialogue type from among the correlated section types 165. For example, a left position 395 of a particular group 320 that most closely correlates to a vertical reference line 398 on a page (e.g., 205) that is associated with the dialogue type, can cause the position correlator logic section 160 to associate that particular group with the dialogue type, and store such association information as the correlated section types 165.

In other words, if the left position 395 is the same as or closest to the vertical reference line 398, then the position correlator logic section 160 can correlate that particular group to the dialogue type. This procedure can be performed for each of the groups of left positions associated with the screenplay evaluation nodes 145 of the screenplay document 105 and their associated body section sections and types. For example, the correlated types can include a slug line body section type, an action or description body section type, a character in dialogue body section type, a dual character in dialogue body section type, a dialogue body section type, a dual dialogue body section type, a parenthetical body section type, a camera direction body section type, and/or ancillary body section text type. The correlated section types 165 can indicate an appropriately named body section type for each node 145.

Part of the initial pass through the screenplay evaluation nodes 145 is to determine a starting page of the body of the script, so as to avoid the title page and any subsequent pages that are not part of the actual body of the script. The initial pass interpreter logic section can include an extraneous page filter logic section 170, which can filter nodes 145 that are found to be part of the title page or subsequent pages that are not part of the actual body of the script. Once the initial pass interpreter logic section 155 has completed the initial pass, the initial pass results can be provided to a script validation testing logic section 175, which can review and compare the initial pass results against one or more tests to validate that the nodes 145 are actually associated with the body of the script. As used herein the phrase “body of the script” refers to pages or sections of the screenplay document 105 that are not the title page or subsequent pages or sections that are devoid of substantive screenplay elements such as a slug line, an action or description section, a character in dialogue section, a dialogue section, a parenthetical section, a camera direction section, or the like. Even though many screenplays have variances in their margin sets, the one or more tests performed by the script validation testing logic section 175 can function as an artificial human eye that can “see” the shape of the text and confirm whether or not the various body sections are actually part of the body of the script, or are otherwise part of the title page or other extraneous pages of the screenplay document 105.

The initial pass interpreter logic section 155 can also gather and store additional data points such as page count, scene count, all word count, all unique word count, all advanced word count, action word count, action unique word count, action advanced word count, dialogue word count, dialogue unique word count, dialogue advanced word count, and number of characters associated with the screenplay document 105.

Still referring to FIGS. 1A, 1B, 2A, 2B, 3A, and 3B, the screenplay content analysis engine 100 can include a second pass interpreter logic section 180, which can perform a second pass of the nodes 145 of the screenplay document 105 beginning with those nodes previously identified as being on the starting page of the body of the script. The second pass interpreter logic section 180 can include a type correlator logic section 185. Each node 145 can be passed into the type correlator logic section 185 to confirm whether the initial matching of correlated section types 165 was accurate or not. The type correlator logic section 185 can determine or otherwise confirm which named body section type of the screenplay document 105 the node 145 belongs. Factors in the decision process carried out by the type correlator logic section 185 can include the previous node's determination (i.e., made by the initial pass interpreter logic section 115), a left position (e.g., 380) of a body section (e.g., 335) associated with the node, a top position (e.g., 375) of the body section associated with the node, whether the text in the body section includes key terms, whether a line of text within the body section begins or ends with a parenthesis, whether a width (e.g., 390) of a body section (e.g., 355) is wide enough to be considered valid, and/or whether specific words are found in the text of the body section that can indicate text that should be ignored. For example, the second pass interpreter logic section 180 can confirm which body section type of the screenplay document each of the nodes belongs, based at least on a width of each of the screenplay evaluation nodes being wider than a threshold width for each corresponding body section text type. Text that should be ignored can include, for example, a continuation marker or a stamped revision date on each page.

Each of the body sections associated with the nodes 145 can include one or more lines of text. Each of the one or more lines of text can have associated therewith a line type. For example, the type correlator logic section 185 can assign the line type to each line of text and generate correlated line types 190. The correlated line types 190 can store a correlation between each of the lines of text and a corresponding predefined line type. Line types can include, for example, a scene heading line, an action line, a character line, a dual character A line, a dual character B line, a parenthetical line, a dual parenthetical A line, a dual parenthetical B line, a dialogue line, a dual dialogue A line, a dual dialogue B line, an ignored line, and/or an error line. Ignored lines, for example, can be text lines that are within an ancillary text section (e.g., 365). Error lines, for example, can include lines of text that the type correlator logic section 185 cannot identify.

Once the type of line is determined for each line of text, it is accounted for and cataloged appropriately as the correlated line types 190, creating an overall “shape” of the body of the script of the screenplay document 105. The correlated line types 190 can be stored in or on a volatile memory 134, a non-volatile memory 136, and/or a magnetic or optical medium 138 of the one or more storage devices 124 of the screenplay content analysis engine 100.

Each line of text associated with each node 145 can be broken apart into its individual words, which can be tracked and/or cross-referenced by one or more dictionaries. The one or more dictionaries can include, for example, an embedded searchable dictionary 126 (e.g., embedded or otherwise included in the screenplay content analysis engine 100), an online searchable dictionary, a network-attached searchable dictionary, a direct-attached searchable dictionary, or the like. The type correlator logic section 185 can determine a word type for each of the individual words, and catalog them as correlated word types 195. The correlated word types 195 can be stored in or on a volatile memory 134, a non-volatile memory 136, and/or a magnetic or optical medium 138 of the one or more storage devices 124 of the screenplay content analysis engine 100. The types of words can include, for example, a unique type of word, an advanced type of word (e.g., words exceeding a specific length or uncommonly used in everyday language), a typical word (e.g., typical words used in a screenplay), or the like. The type correlator logic section 185 can determine a count for each type of word. For example, the type correlator logic section 185 can count the total number of words having the unique type, the total number of wards having the advanced type, the total number of words having the typical type, and so forth. The total number of words for each word type can be counted for the entire body of the script for the screenplay document 105, or for a subsection of the screenplay document 105 such as only the body of the script. The correlated word types 195 can be used for later examination and analysis of the screenplay document 105 as further described below.

The second pass interpreter logic section 180 can include a character name extractor logic section 192. As the second pass through the screenplay evaluation nodes 145 proceeds, the character name extractor logic section 192 can capture character names and each character's associated dialogue in a character name and associated dialogue array 194. The character name and associated dialogue array 194 can be populated in reliance on the body sections previously identified as the character in dialogue sections 315 and the dialogue sections 320 among the correlated section types 165. Alternatively or in addition, the character name and associated dialogue array 194 can be populated in reliance on the correlated line types 190.

Each character in dialogue section (e.g., 315) is followed by a dialogue section (e.g., 320). In other words, text following the character's name is what is being spoken by that character. Consequently, the character name extractor logic section 192 can capture and associate all of the dialogue sections that are associated with a particular character name When a new character name is discovered, a new entry to the character name and associated dialogue array 194 can be created and appended to the array 194. The character name extractor logic section 192 can assign the newly discovered character name to the new entry in the array 194. The character name extractor logic section 192 can populate the new entry with all of the dialogue sections (e.g., 320, 330, 350, etc.) associated with that particular character name. Once the last of the ordered screenplay evaluation nodes 145 is reached in the second pass, a complete character name and associated dialogue array 194 has been created. Each entry in the array 194 can include a character name, the dialogue sections (e.g., 320, 330, 350, etc.) associated with that particular character name, one or more page numbers on which the dialogue sections associated with that particular character name appear, and/or one or more scenes in which the dialogue sections associated with that particular character name is associated.

The second pass interpreter logic section 180 can include an array examination logic section 196, which can examine the entries of the character name and associated dialogue array 194. First, the array examination logic section 196 can detect and merge any duplicate entries in the array 194. For example, sometimes in screenplays a character's first and last name are used together initially, and then later in the script reference is made to the character by first name only, thus creating two entries for the same character within the array 194. When the array examination logic section 196 detects these two different entries of the array 194 that represent the same character, the two entries in the array 194 can be merged into one entry. In other words, when two different entries include different information for the same character, the two array entries can be merged, and one of the two entries in the array 194 removed or ignored.

The array examination logic section 196 can count the number of words and lines of dialogue for each character, and can store the word count and the line count in the corresponding entry of the array 194 associated with the corresponding character. The array examination logic section 196 can sort the character name and associated dialogue array 194 so that characters with which the most dialogue (e.g., word count) is associated are at one end (e.g., the top) of the array of entries and descending in order by word count per character.

The array examination logic section 196 can determine whether each entry in the array 194 includes a major character or a minor character. The array examination logic section 196 can compare the word count associated with each character to a word count threshold to make the determination. For example, if a particular entry includes a character having a word count that exceeds the word count threshold, then such character can be designated as a major character. The word count threshold can be dependent on or otherwise determined with reference to the character having the highest word count. In other words, the character having the highest word count can be determined, and designated a major character, and then those other characters that have a word count that exceeds that word count, minus an offset, of such major character, then they too can be designated as major characters. Comparing all subsequent characters to the character with the highest word count, the word count threshold can be determined and compared against to determine whether a particular character's word count indicates that they are a major character or a minor character. When categorizing major and minor characters, the array examination logic section 196 can take other factors into account such as the number of scenes the character is referenced in, the spread of script the character is referenced in, or the like.

The result of the second pass of interpreting the screenplay evaluation nodes 145 is a screenplay document that has been broken down into its various parts, and can be stored in or on a volatile memory 134, a non-volatile memory 136, and/or a magnetic or optical medium 138 of the one or more storage devices 124 of the screenplay content analysis engine 100. All the action text is stored separately from dialog, and character names have been gathered and associated with the dialog. The individual words of the body of the script have been broken apart and tracked into separate dictionaries for different purposes. The text of the body of the script has been separated by page and by scene.

### III. Deep Interpretation of a Screenplay

This section involves the interpretation of the screenplay at a deeper level to gather more about the story and about the characters. Still referring to FIGS. 1A, 1B, 2A, 2B, 3A, and 3B, the screenplay content analysis engine 100 can include a deep interpreter logic section 182, which can perform a deep interpretation of the ordered screenplay evaluation nodes 145 and associated information of the screenplay document 105. Using the character name and associated dialogue array 194, the deep interpreter logic section 182 can examine paragraphs of action text (e.g., action or description section 355) in linear order from the beginning of the body of the script to the end looking for the each occurrence of each character name noted in the array 194. Once the text of a particular character name is found, the deep interpreter logic section 182 can examine the nearby text to isolate the text that is pertinent to only that character. This pertinent text can include text that is both before and after the particular character name For example, the deep interpreter logic section 182 can examine text that is within a predefined character count before the particular character name, and/or that is within a predefined character count after the particular character name During this examination, if a different character name is encountered, or certain punctuation is encountered, the deep interpreter logic section 182 can stop associating the text beyond that point as pertinent text to the particular character. The deep interpreter logic section 182 can evaluate the captured segment of text that is pertinent to the particular character for information relating to the particular character, and can store the pertinent text in the character name and associated dialogue array 194 in an entry associated with the particular character.

For each character name, the deep interpreter logic section 182 can search for age-identifying text whether in numerical form or spelled out in text, such as “twenty-five” or “25.” In addition, the deep interpreter logic section 182 can search for other age-identifying information such as “teenager” or “child.” Age-identifying information may be a range rather than a specific number. For example, “in his 60s” can refer to 60-69 years of age. When more than one numerical reference is found that could be an age, the deep interpreter logic section 182 can determine which among the age-identifying text is most likely to indicate the age of the character. For example, the deep interpreter logic section 182 can choose likely ages or those in closer proximity to the character name A likely age, for example, would exclude numbers above 100 or less than zero (0). In some instances, the deep interpreter logic section 182 may detect a likely age range for a particular character, rather than a single age. Once the age range is determined, the deep interpreter logic section 182 can assign the age or age range to the character in the character name and associated dialogue array 194 as data values such as “age,” “age min,” “age max,” or the like.

For each character name, the deep interpreter logic section 182 can search for gender-identifying text to identify the character's likely gender. The deep interpreter logic section 182 can access a name-gender database 128 of predefined names and associated genders. The name-gender database 128 can include an embedded searchable name-gender database (e.g., embedded or otherwise included in the screenplay content analysis engine 100), an online searchable name-gender database, a network-attached searchable name-gender database, a direct-attached searchable name-gender database, or the like. For example, the deep interpreter logic section 182 can find the name “Jim” within the name-gender database 128 and identify it as a male. By way of another example, the deep interpreter logic section 182 can find the name “Mary” within the name-gender database 128 and identify it as a female.

Should the name not be found in the name-gender database 128 or the name is considered ambiguous, such as “Pat,” then the deep interpreter logic section 182 can search for additional gender terms within the text in the order of being most definitive. For example, the word “male” or term “a man” is more likely to relate to the particular character than simply “he” or “she.” Thus, the word “male” and term “a man” can be given more weight in guessing the gender of the particular character than the terms “he” or “she” within the text. Once the likely gender is determined, the deep interpreter logic section 182 can assign the gender to the particular character and associated entry in the character name and associated dialogue array 194, for example, as a data value titled “gender.” Alternative gender identifications can be used without departing from the inventive concepts disclosed herein.

The deep interpreter logic section 182 can identify character attributes of each of the characters. Character attributes are predefined descriptors categorized into race, nationality, and physical attribute, or the like. The character attributes can include sub-attributes. For example, sub-attributes in the category of physical attribute may include athletic, small, wimpy, or the like. Each sub-attribute can have associated therewith a plurality of terms, that if found by the deep interpreter logic section 182, can trigger the deep interpreter logic section 182 to assign the sub-attribute to the character. For example, if the word “puny” is found to be anywhere in a segment of text associated with a particular character name, the deep interpreter logic section 182 can attach the sub-attribute “wimpy” to that particular character within the character name and associated dialogue array 194 because the term “puny” is a synonymous or sufficiently related term for the sub-attribute “wimpy.” One or more synonymous or related terms for each sub-attribute are searched for within the text associated with each character name. The deep interpreter logic section 182 can create and store a list of sub-attributes for each attribute category for each character within the character name and associated dialogue array 194.

The deep interpreter logic section 182 can detect story elements 184 for the screenplay. The story elements 184 can include predefined descriptors that describe a key component of the story. Each of the story elements 184 can correspond to at least one of an overarching theme of a story, an object of a story, or an action-based component of a story. For example, each story element 184 can include an overarching theme such as “family,” or common props like “space ships.” More examples of elements include “adoption,” “coming of age,” “disability,” “dance,” or the like. The story elements 184 can also include sub-elements of a greater element, as in the example of the “sports” element, which can contain sub-elements such as “football,” “baseball,” or the like. Part of the intelligence of the deep interpreter logic section 182 is to find and match the story elements and sub-elements in the body of the script to the story elements 194, and to discern whether to rollup the sub-elements into the greater story element. For example, as in the example of “sports,” the deep interpreter logic section 182 can find a designated number of sub-elements (“football,” “baseball,” or the like) that may cause the deep interpreter logic section 182 to choose only the parent element of “sports” as a central story element for inclusion in a final list 188 of story elements. On the other hand, if the deep interpreter logic section 182 finds a high number of “basketball” references without significant reference to other kinds of sports, then the deep interpreter logic section 182 to choose the sub-element of “basketball” as a central story element 184 for inclusion in the final list 188 of story elements. The deep interpreter logic section 182 can save and/or report one or more story elements from among the story elements 184 that were found to be central story elements and saved in the list 188.

The deep interpreter logic section 182 can apply a weight 186 to each story element that is matched from among the story elements 184. When matching terms are found (i.e., terms that are associated with a story element or sub-element) in the body of the script, then additional weight can be added to the corresponding story element. The weights 186 for the story elements 184 can continue to add up as the deep interpreter logic section 182 examines the body of the script. The deep interpreter logic section 182 can then evaluate the story elements 184 and weights 186 to derive a final list 188 of story elements. An examination of a single screenplay may detect over 300 story element matches, but only those with the highest weights and that have found specific types of terms are selected for the final list 188 of story elements for the screenplay. For example, the weights 186 can be compared to a predefined threshold, and only those story elements 184 having calculated weights 186 that exceed the predefined threshold can be included in the final list 188 of story elements.

For example, for the story element “high school,” some of the matching terms may include “eleventh grade,” “homecoming dance,” or “freshman ” Because matching terms can have different importance toward the overall story element, the deep interpreter logic section 182 can assign the matching terms a corresponding type designation 172 that impacts their weight. The type designations 172 can include, for example: “major,” “key,” “supportive,” “arbitrary,” “canceling,” or the like. The major and key type designations show a strong indication that the matched term reflects the story element. Supportive terms can often be found in the same context or proximity, but are less of an indication that the matched term reflects the story element. In the example of “high school,” the term “college application” can add more supportive evidence, but is not a strong decider that the story element “high school” should be selected for inclusion in the final list 188 of story elements for the screenplay. The “college application” term may be considered a supportive type designation, rather than a major or key designation from among the type designations 172.

Arbitrary terms can provide evidence as well for a particular story element, but the deep interpreter logic section 182 can consider them as having less weight because such arbitrary terms can have multiple meanings, and may not be related to the story element at all in the context used. An example of an arbitrary term for the story element “high school” can be “senior.” While the term “senior” might refer to a “senior” in “high school,” the term could also be referring to a senior citizen. Thus, the deep interpreter logic section 182 can give less weight to the term “senior” when determining which story elements to include in the final list 188.

Canceling terms can be used to protect from entirely different meanings. For example, a matching term of “bald” would normally be considered to refer to a person who has lost their hair. However, the canceling term “bald eagle” can be used by the deep interpreter logic section 182 to ignore the word “bald” if what is really found in the text is “bald eagle.” Matching terms can also have “proximity” and “character” designations from among the type designations 172 that can affect the detection and weighting of those terms. Proximity can allow for a matching term containing multiple words to not require an exact phrase match, but allow for the words to be within close proximity, and still be considered a match. A character designation can add more weight if the deep interpreter logic section 182 detects the matching term nearby a character name or reference to a person. For example, in the case of the text “Jim is in ninth grade,” the deep interpreter logic section 182 can apply greater weight because one of the characters of the story (i.e., Jim) is in ninth grade. If Jim is a “major” character as indicated by the type designations 172, then the deep interpreter logic section 182 can apply even more weight to the story element (e.g., “high school”) due to the “is in the ninth grade” phrase being proximally located to the major character “Jim.”

Screenplays, even more so than other literary works, rely on subtext. The structure and function of the story element system is designed to key in on this subtext though intelligent handling of matching terms, and selecting different designations when looking at action or description text (e.g., action or description section 310) versus dialogue text (e.g., dialogue section 315). Irony and sarcasm present general challenges to artificial intelligence. In accordance with embodiments of the inventive concept, much of this intelligence comes down to the setup of the terms, their type designations, quantities, and weights, such that the deep interpreter logic section 182 can examine and interpret these terms by detecting the subtleties of writing within screenplays.

The deep interpreter logic section 182 can examine both the stored dialogue text (e.g., dialogue section 315) and action or description text (e.g., action or description section 310) searching for matching terms associated with story elements 184. The matching terms can be compared against the text for each scene or page in the screenplay document 105. If a term is found in the text, the deep interpreter logic section 182 can apply a weight 186 to that term's corresponding story element 184 depending on the type designation 172, and optionally depending on the relation of a character. Once a term is found within the scene or page, the deep interpreter logic section 182 can count or select such term once for consideration for that scene or page. Additional identical terms within that scene or page can have less weight applied to avoid a saturation of weight. Moreover, the deep interpreter logic section 182 can detect writing oddities such as text within a screenplay that simply names a list of universities, which could otherwise cause a story element “college” to be over-weighted. In such cases, the deep interpreter logic section 182 can throttle or reduce the weight for a given story element.

Each story element can have its own manually adjustable weight setting that determines how weight is calculated for that story element. In other words, a user of the screenplay content analysis engine 100 can change the adjustable weight settings per individual story element if desired. The adjustable weight settings can include “sensitivity,” “spread easement,” “repeat tolerance,” “character importance,” “dialogue importance,” or the like.

For example, decreasing a story element's sensitivity setting may be appropriate if the terms or overall story element are common themes throughout movies, and that specific story element requires more evidence for inclusion in the final list 188 of story elements. The spread easement adjustable weight setting causes the deep interpreter logic section 182 to include a particular story element in the final list 188 only if the story element is substantially referenced throughout the entire body of the script, as opposed to just a limited number of back to back scenes or pages.

The repeat tolerance adjustable weight setting dictates how much impact a single term will have for a story element if it is repeated throughout the body of the script. For example, if the repeat tolerance is set to be low, then the single repeated term does not significantly impact the weight applied to the corresponding story element. Conversely, if the repeat tolerance is set to be high, then the single repeated term can have greater impact on the weight applied to the corresponding story element.

The character importance and dialogue importance settings can alter the weight applied to a given story element when the terms are found relating to a character or are in dialogue. For example, a higher dialogue importance setting and a lower character importance setting can cause the deep interpreter logic section 182 to more heavily weight a particular story element when terms appear in the dialogue sections (e.g., dialogue section 320), and to apply less weight when the terms appear in association with the character (e.g., character in dialogue section 315).

Once the deep interpreter logic section 182 has identified the matching terms and story elements, then the deep interpreter logic section 182 can sort the story elements by individual weights. The deep interpreter logic section 182 can select those story elements having the highest weights and include those in the final list 188 of story elements. During this selection process, the deep interpreter logic section 182 can also evaluate the list 188 of elements, applying rules to ensure only story elements truly applying to the story of the screenplay are selected.

The deep interpreter logic section 182 can limit the number of story elements included in the final list 188 to a predefined maximum number. The limiting rules can also include, for example, a rule that states that no matter how much weight a story element has, if none of the terms found were designated as “major” or “key” in accordance with the type designations 172, then the story element is not selected for inclusion in the final list 188. Alternatively or in addition, the deep interpreter logic section 182 can compare and filter “like” elements so only the most pertinent story elements to the story are chosen. The final selection of story elements in the final list 188 portrays a realistic picture of what the screenplay is about.

The slug lines within slug line sections (e.g., 305) of the screenplay document (e.g., 105) often contain valuable information regarding both location and time periods. The deep interpreter logic section 182 can examine each slug line section for key words that can determine either or both of the location and the time period. The deep interpreter logic section 182 can maintain a list of predefined time periods, and when matched with time period terms used in the slug line sections, the deep interpreter logic section 182 can assign or store a predefined time period to the screenplay document 105.

In addition, the deep interpreter logic section 182 can identify when the time period or location has changed within the body of the script. The deep interpreter logic section 182 can assign a percentage of time to each time period detected. In other words, the deep interpreter logic section 182 can detect a first time period within the body of the script, a second time period, and so forth, and assign percentages to each based on their prevalence in the body of the script. This can result in valuable information such as the story taking place 30% of the time in New York and 70% of the time in Paris, and so forth. Locations can be general, specific, or complete fantasy. An example of general is “small town USA,” where specific may be a bar in Portland, Oreg., and fantasy may be the name of a fictional planet in a science fiction story.

Prior to or following the interpretation of the body of the script, the deep interpreter logic section 182 can examine the title page of the screenplay document 105 to retrieve the title of the screenplay, the writer or writers, the revision date if listed, or the like. Following the same or similar technique as with the body of the script, the title page can be interpreted by sections of text with “top” and “left” positions. While most title pages follow the same format, some can vary, which makes this type of detection more difficult.

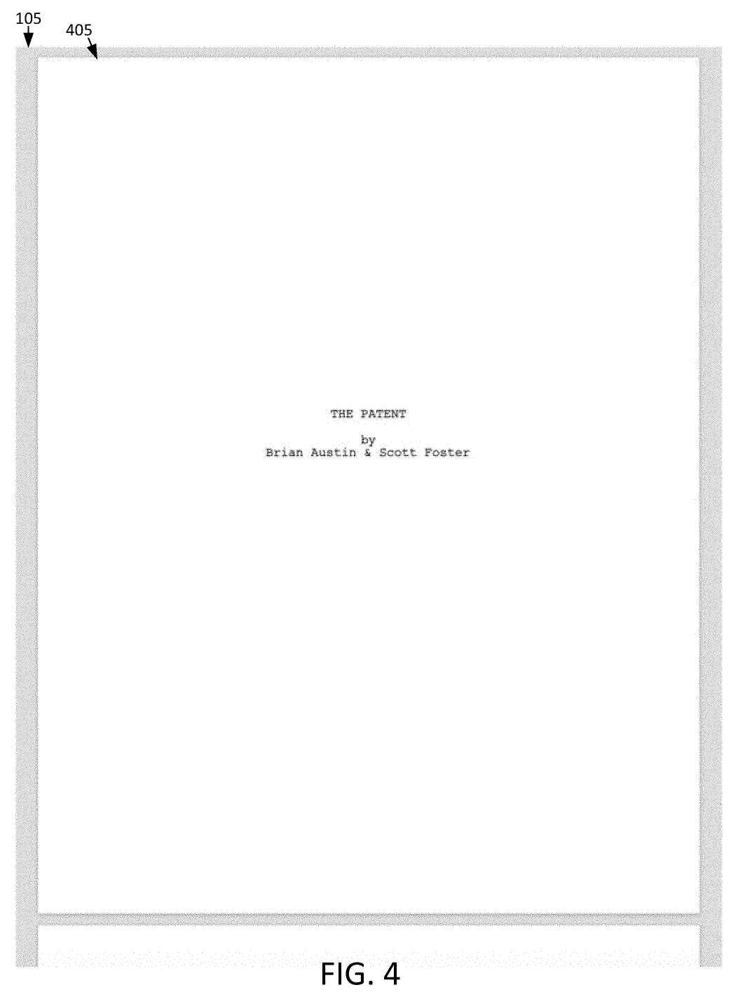

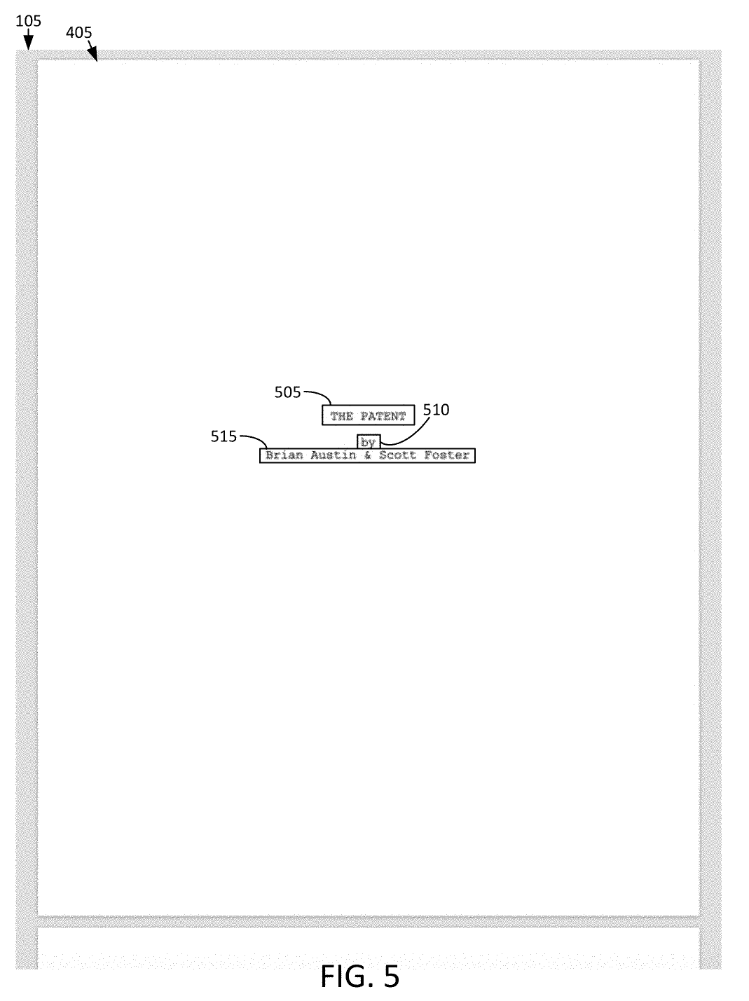

FIG. 4 is an example of a screenplay title page 405 of the screenplay document 105. FIG. 5 identifies components of the title page 405 of FIG. 4. Reference is now made to FIGS. 4 and 5.

The deep interpreter logic section 182 can determine a difference between a title 505 appearing on the title page 405 and one or more writers 515 appearing on the title page 405. For example, the deep interpreter logic section 182 can locate the word “by” (e.g., 510). The word “by” is useful because what follows is usually the one or more writers 515 and what precedes is usually the title 505. The deep interpreter logic section 182 can perform an additional check to compare names of the one or more writers 515 to the name-gender database 128 to further verify that what the deep interpreter logic section 182 thinks is a name is actually a name Although not shown on the title page 405, sometimes a block of text includes a date. The deep interpreter logic section 182 can detect, decipher, and/or store the date text that is found. The date usually refers to a revision date. The deep interpreter logic section 182 can also detect, decipher, and/or store the screenplay's title 505 and the one or more writers 515.

After the deep interpreter logic section 182 completes its deeper examination of the screenplay document 105 and associated screenplay evaluation nodes 145, character information, story elements, attributes, locations, time periods, and other related information have been found, examined, categorized, and/or stored such that a complete breakdown of the text of the screenplay document 105 is completed, and is made ready for further analysis of the data to gather further insights into the screenplay document 105.

### IV. Analysis of the Interpretation

The screenplay content analysis engine 100 can include a screenplay analysis logic section 174 to analyze the information broken down by the interpreter logic sections (e.g., 155 and 180). The screenplay analysis logic section 174 can use the story elements from the final list 188 of selected story elements to derive the screenplay's genre. Examples of film genre can include, for example, “drama,” “comedy,” “horror,” “science fiction,” “thriller,” “adventure,” or the like. The screenplay analysis logic section 174 can maintain a predefined list of genres specific to film, and a predefined list of genres specific to television. The screenplay analysis logic section 174 can assign a genre to each story element from the selected story elements list 188 as either a potential linkage or a very likely linkage. Such assignments need not exclude further designations of linkages. As story elements from the list 188 are examined one by one, the screenplay analysis logic section 174 can generate a weighted genre list 176, which includes a list of weighted genres.

The screenplay analysis logic section 174 can use the weighted genre list 176 to determine the most likely genre or genres associated with the screenplay document 105. For example, the more linkages or matches between the selected story elements from the list 188 and the genres in the predefined list of genres (i.e., specific to either film or television), then the greater the weight that the screenplay analysis logic section 174 assigns to a particular genre. The screenplay analysis logic section 174 can then determine which genre or genres within the weighted genre list 176 has the highest weight or weights, and select that genre or those genres as the overall one or more selected genres 178 of the film or show.

The screenplay analysis logic section 174 can implement and/or use one or more formulas that take the selected story elements 188 and the selected one or more genres 178 into account. Employing these formulas, the screenplay analysis logic section 174 can alter the final list 188 of story elements and/or the one or more selected genres 178 in an additional decision-making capacity. The formulas further assist with detecting subtext within writing, particularly with genres such as “comedy.” An example of a formula includes a controversy dampening technique, such as a situation in which the screenplay analysis logic section 174 finds that the story element “racism” exists in the list 188 along with multiple comedic story elements in the list 188. In this scenario, the screenplay analysis logic section 174 can ensure that the selected one or more genres 178 corresponds to “comedy” instead of “racism.”

The screenplay analysis logic section 174 can examine and store additional data points from the previous interpretive passes to derive more analytics. Data points of the interpretation can include, for example, line count, page count, scene count, all word count, all unique word count, all advanced word count, action word count, action unique word count, action advanced word count, dialogue word count, dialogue unique word count, dialogue advanced word count, and number of characters. The screenplay analysis logic section 174 can derive new data points from the data points gathered during the previous interpretations. The new data points can include, for example, dialogue to action ratio or complexity of the dialogue through a measure of counts and story element comparisons.

The screenplay analysis logic section 174 can use the story elements from the list 188, the selected one or more genres 178, and/or other data points to derive a predicted content rating (e.g., G, PG, PG-13, R, or the like) that the screenplay may likely receive in the theater or on television. In some embodiments, the screenplay analysis logic section 174 can predict a content rating based on at least one of (a) the final list 188 of story elements, (b) explicit dialogue, or (c) story elements not included in the final list 188 of story elements. In addition, the screenplay analysis logic section 174 can call out the reasons such as “strong language,” “violence,” or “sexual situations.” The screenplay analysis logic section 174 can also derive shooting schedules and budget range with reference to the story elements 188, locations, and/or character dialogue spread.

The screenplay analysis logic section 174 can save an analysis summary associated with a particular screenplay document 105. The screenplay analysis logic section 174 can compare the saved analysis to other saved analysis summaries associated with other screenplay documents for different screenplays. The screenplay analysis logic section 174 can also receive external data including, for example, box office results, social media stats, critical reviews, or the like, which can provide additional data points for an expanded analysis. Such additional data points can include, for example, predictive box office numbers. The screenplay analysis logic section 174 can access a library of screenplay documents, which can provide additional baseline data points such as dialogue complexity or what may be considered standard or good writing characteristics for screenplays. Deviations outside of the baseline data points can alter the analysis of the screenplay document 105 performed by the screenplay analysis logic section 174.

### V. Uses of the Resulting Analysis

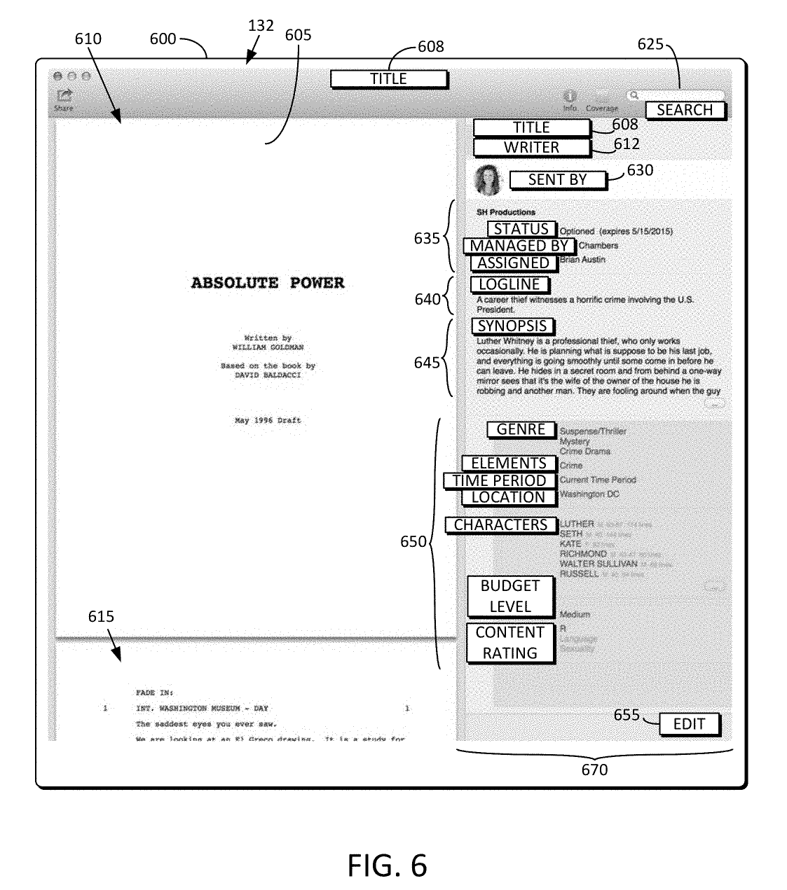

FIG. 6 illustrates a block diagram including an example of the user interface 132 of the screenplay content analysis engine 100 accessible via a display 600. In some embodiments, the display 600 is directly coupled to the screenplay content analysis engine 100. In some embodiments, the display 600 is coupled via a wired or wireless network to the screenplay content analysis engine 100. For example, the display 600 can be that of a mobile device such as a smart phone or tablet, which can access the screenplay content analysis engine 100, and can be served information via the user interface 132 over the network.

The user interface 132 shows an example of how the analysis of a screenplay document 605 can efficiently and elegantly inform a user of key information regarding the screenplay. For example, the user can be presented with a full view of each page (e.g., 610, 615, and so forth) of the screenplay document 605. The user interface 132 can further include a side panel 670 of information. The side panel 670 can include document management information related to workflow as well as text of the screenplay itself, which can be entered manually. The user can be quickly informed about the title 608, the writer 612, and summary information 650, which can include genre, story elements, time period, location, character information, budget level, and/or content rating.

The side panel 670 can further include an edit button 655 which when selected by the user, allows the user to make edits to the screenplay document 605 or to information associated therewith. The side panel 670 can further include a synopsis section 645, which provides an overall synopsis of the screenplay document 605, a logline section 640, which provides a short one-sentence description of the screenplay document 605, and a status section 635, which can provide status information such as expiration date, “managed by” information including a manager name, and/or “assigned” information including a person to whom the screenplay document 605 is assigned. The side panel 670 can further include “sent by” information 630, signifying a person from whom the screenplay document 105 was sent. In addition, the side panel 670 can include a search box 625 in which the user can input keywords for searching within the screenplay document 605.

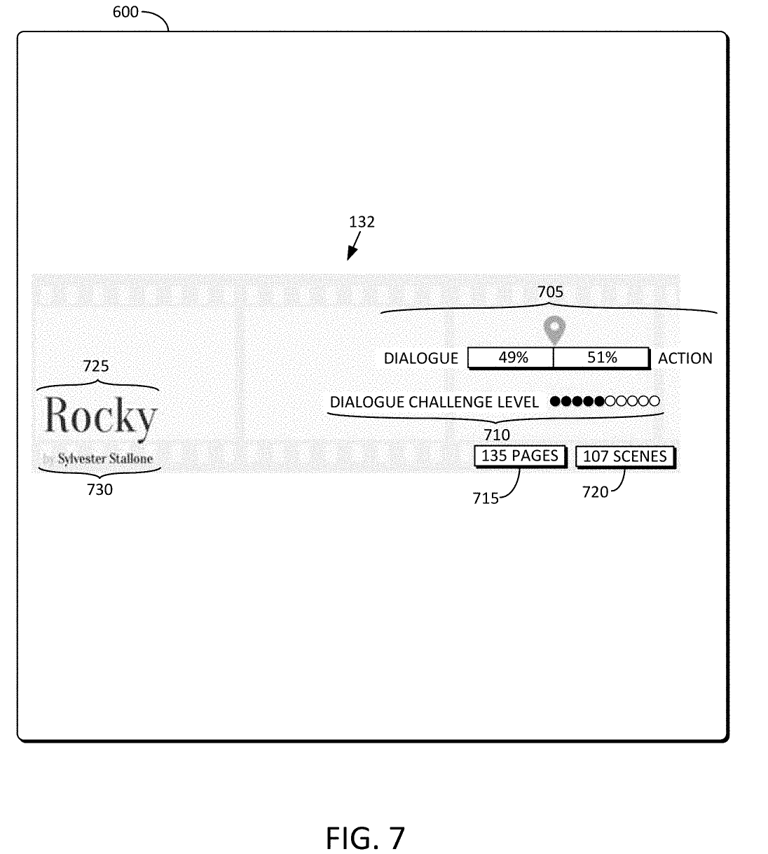

FIG. 7 illustrates a block diagram including another example of the user interface 132 of the screenplay content analysis engine 100 accessible via the display 600. The user interface 132 can include a dialogue to action ratio graph 705, and a dialogue challenge level graph 710. The dialogue to action ratio graph 705 can show a percentage breakdown and comparison between dialogue and action within the screenplay document (e.g., 105, 605, or the like). The dialogue challenge level graph 710 can show a challenge level (e.g., how challenging the language, script, acting requirements, or the like) of dialogue within the screenplay document (e.g., 105, 605, or the like). The user interface 132 can include the number of pages 715 and the number of scenes 720 in the screenplay document (e.g., 105, 605, or the like). In addition, the user interface 132 can include the title 725 and author 730 of the screenplay document (e.g., 105, 605, or the like).

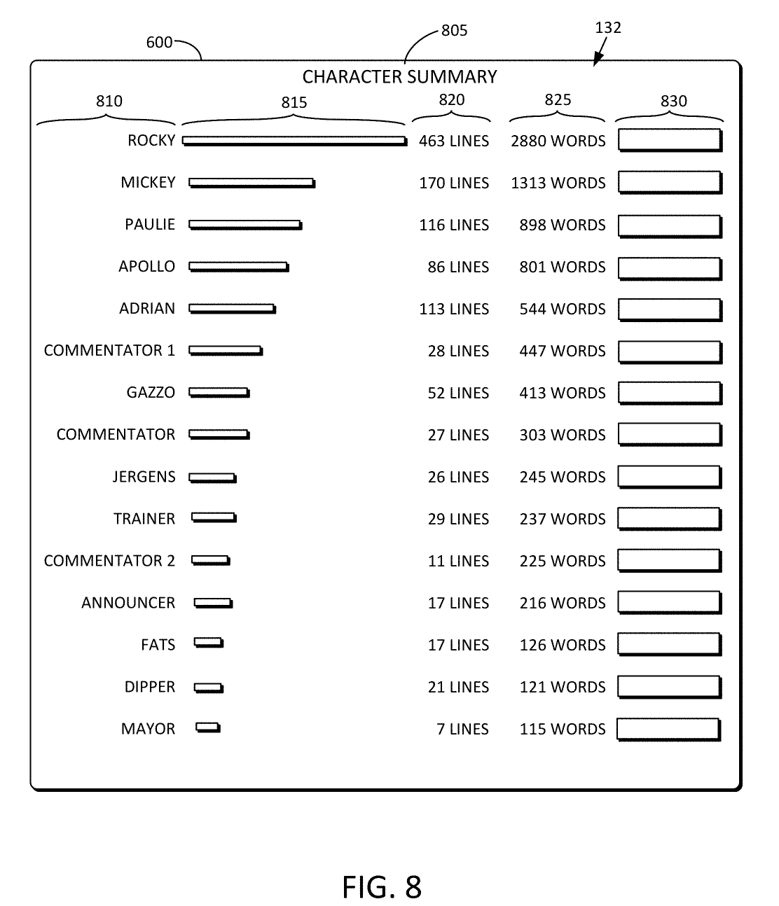

FIG. 8 illustrates a block diagram including yet another example of the user interface 132 of the screenplay content analysis engine 100 accessible via the display 600. The user interface 132 can include a summary of the deeper level analysis of the screenplay document (e.g., 105, 605, or the like). For example, the summary can include a character summary 805. The character summary 805 can include a list of character names 810 associated with the screenplay document (e.g., 105, 605, or the like). The character summary 805 can include a number of lines section 820 that shows the number of lines associated with each character name in the body of the script. The character summary 805 can include a number of words section 825 that shows the number of words associated with each character name in the body of the script.

The character summary 805 can include a graph section 815, which visually provides an indicator of the importance and/or prominence of each character. The graph section 815 can include a bar graph that appears to the right of each character name, thereby providing instant visual insights into how each character relates to the main character based on the amount of dialogue. In addition, the character summary 805 can include a character details section 830, which includes additional details for each of the characters. The additional details in the character details section 830 can include gender, age, race, and/or physical characteristics. Thus, the character summary view 805 of the characters 810 found within the screenplay document (e.g., 105, 605, or the like) demonstrates an ordering of characters from major to minor, and their associated information such as line count, word count, gender, age, race, and physical attributes.

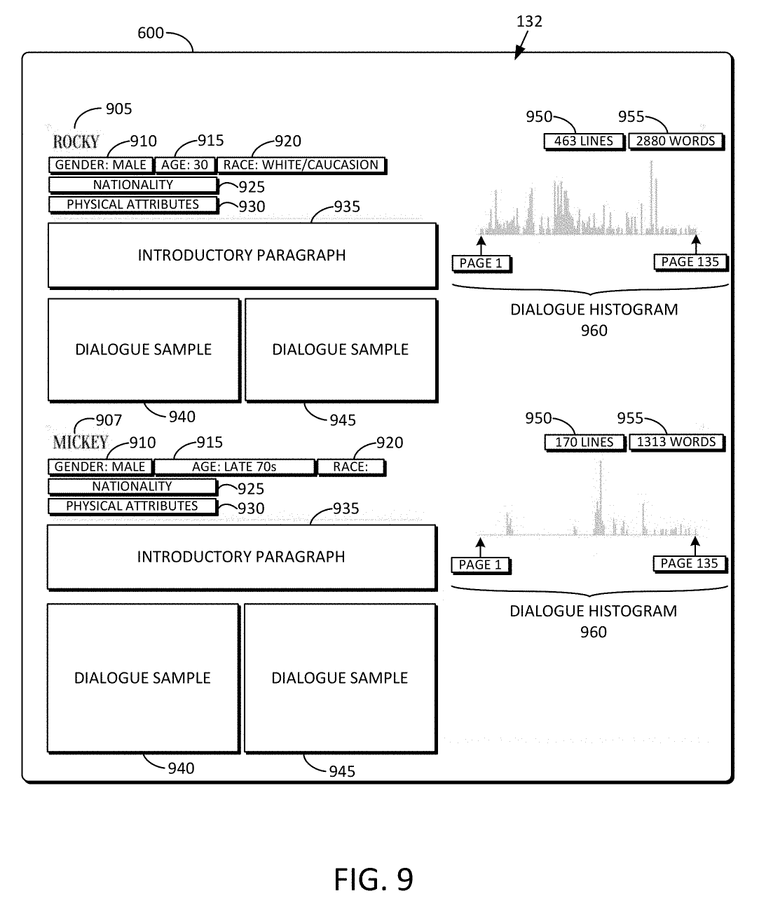

FIG. 9 illustrates a block diagram including still another example of the user interface 132 of the screenplay content analysis engine 100 accessible via the display 600. The user interface 132 can include a detailed view per character name within the screenplay document (e.g., 105, 605, or the like). The user interface 132 can show under each character name (e.g., 905 and 907) the traits of the character, such as gender 910, age 915, race 920, nationality 925, physical attributes 930, or the like. Moreover, the user interface 132 can include an introductory paragraph 935, which can set forth a segment of text from the body of the script that introduces the character. In addition, the user interface 132 can include two primary examples of the dialogue (e.g., dialogue sample 940 and dialogue sample 945) associated with that particular character in the screenplay. Adjacent to each character, the user interface 132 can include a dialogue histogram chart 960 showing how much of the dialogue in the screenplay document, and where (i.e., which page or scene) in the screenplay document, is associated with that particular character. The dialogue histogram chart 960 can also include a total number of lines 950 and total number of words 955 associated with that particular character. The dialogue histogram chart 960 is useful in determining screen time and how much that particular character may be spread across different screens for shooting schedules.

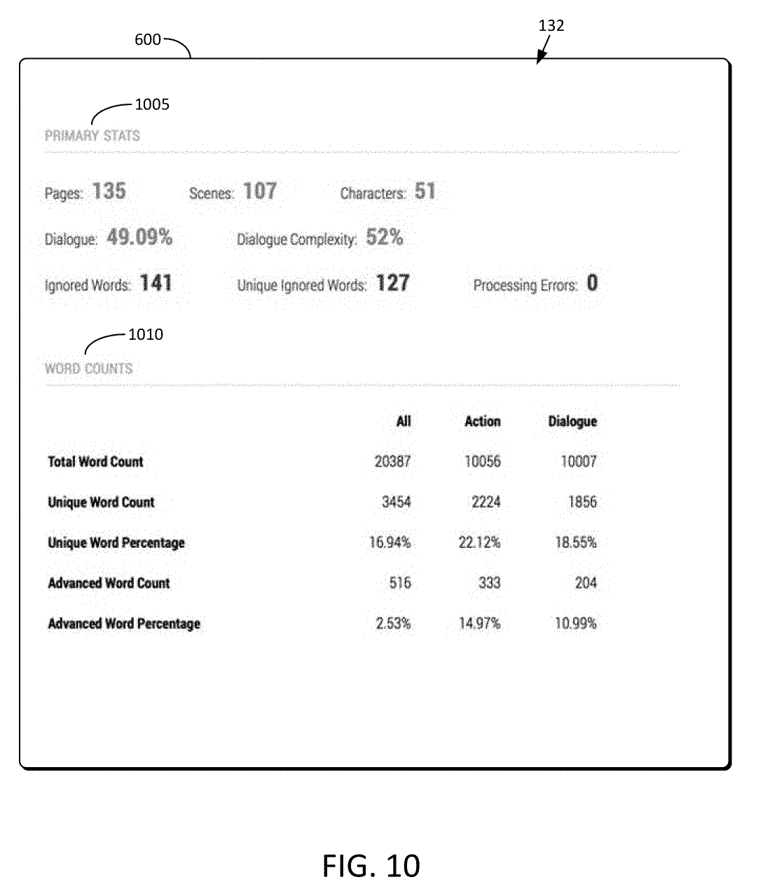

FIG. 10 illustrates a block diagram including another example of the user interface 132 of the screenplay content analysis engine 100 accessible via the display 600. The user interface 132 can include a primary stats section 1005 and a word counts section 1010. The primary stats section 1005 can include primary statistics of the screenplay document (e.g., 105, 605, or the like), such as number of pages, number of scenes, number of characters, percentage of dialogue, percentage of dialogue complexity, number of ignored words, number of unique ignored words, and/or processing errors. The word counts section 1010 can include a total word count, a unique word count, a unique word percentage, an advanced word count, and/or an advanced word percentage. The word counts section 1010 can break out that information by action, dialogue, or all combined.

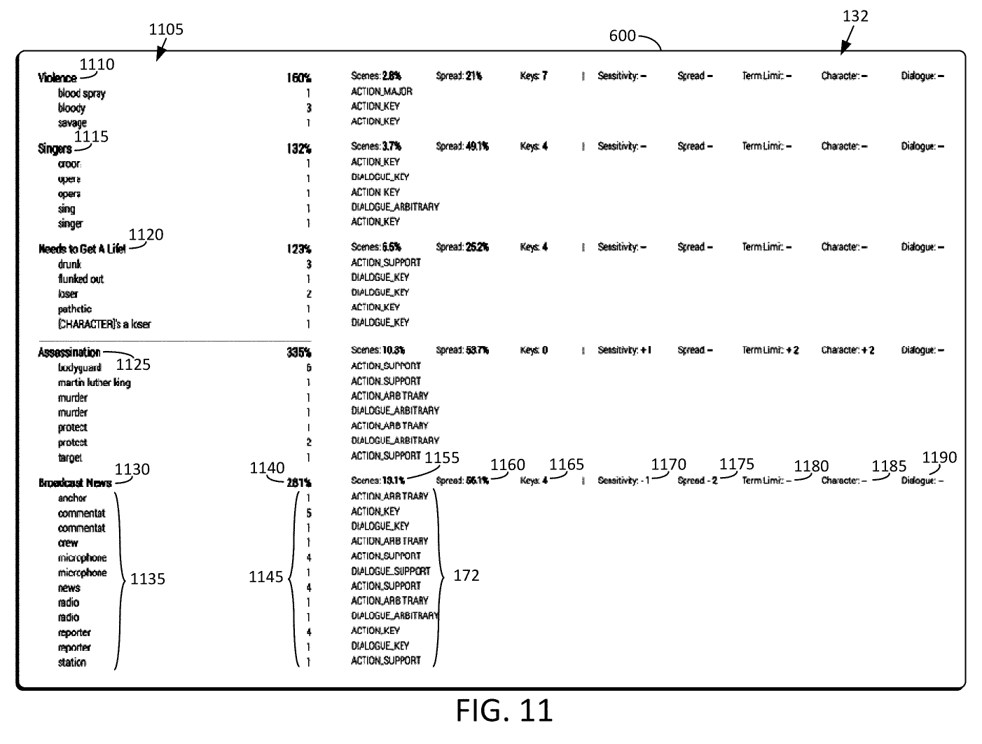

FIG. 11 illustrates a block diagram including another example of the user interface 132 of the screenplay content analysis engine 100 accessible via the display 600. The user interface 132 can include a sample outputting 1105 of story elements (e.g., 1110, 1115, 1120, 1125, and 1130) from among the final list 188, and associated terms (e.g., 1135) found for each selected story element in the screenplay document (e.g., 105, 605, or the like). Displayed adjacent to each story element is a weight 1140. Each story element can be weighted differently than another, and only those having sufficient weight, signifying it being a chosen story element, can be displayed in the user interface 132. A number of “hits” 1145 of terms found for each story element can be shown. In other words, the number of instances in which a particular term is found in the body of the script can be counted and shown. The percentage of scenes 1155 can be shown relative to each story element. In addition, other information relevant to each story element can be displayed, such as type designations 172, spread 1160, a number of key type designations 1165, a sensitivity measurement 1170, a spread measurement 1175, a term limit measurement 1180, a character score 1185, and/or a dialogue score 1190.

While various examples of the user interface 132 are provided, it will be understood that the analysis information can also be transmitted to a separate system as a direct input into the separate system. In other words, a human user need not directly view or comprehend the analyzed information via the user interface 132. Rather, a computer user or remote system can receive the analyzed screenplay information via a network, process the analyzed screenplay information, store the analyzed screenplay information, or otherwise make use of the analyzed screenplay information without the requirement of interfacing with human users.

Agencies, studios, and other entities that maintain libraries of screenplays employ readers to perform “coverage” on any scripts they add to their library. This process involves reading the script and writing up that information into a separate document. This separate document covers the basics such as title, writers, and genre. It can also go far deeper to describe characters, the “logline,” synopsis, and their opinions on the material. The efficiency of this task can be greatly improved by the use of the screenplay content analysis engine 100 disclosed herein for automatically populating much of the mundane part of this process such as character names and descriptions. Moreover, the screenplay content analysis engine 100 can be more effective and go further and faster than a human reader in detailing things like character line counts, which is difficult or impossible for human readers, and often fraught with error and accuracy issues if performed by a human. The screenplay content analysis engine 100 increases the number of screenplays that can be covered per day/week/month/year, and enhances and simplifies the jobs of those wanting to focus on opinion rather than mundane and unwieldy detail.

The screenplay content analysis engine 100 can catalog multiple analyses of a plurality of screenplays, thereby building a library of screenplays and associated analysis for each screenplay. Access can be given to outside agencies to enhance their own libraries. Conversely, the screenplay content analysis engine 100 can import screenplays from external libraries. The screenplay content analysis engine 100 provides the capability of searching within a particular screenplay or across multiple screenplays in a library. For example, an agent at an agency representing a muscular African American client in his 60s can almost instantly be provided a list of screenplays with a character that matches that description. In some embodiments, the screenplay content analysis engine 100 can include act in an active role (rather than reactive), tracking trends of the market and social landscape to provide a weekly list of screenplays including recommended screenplays for that time and context.

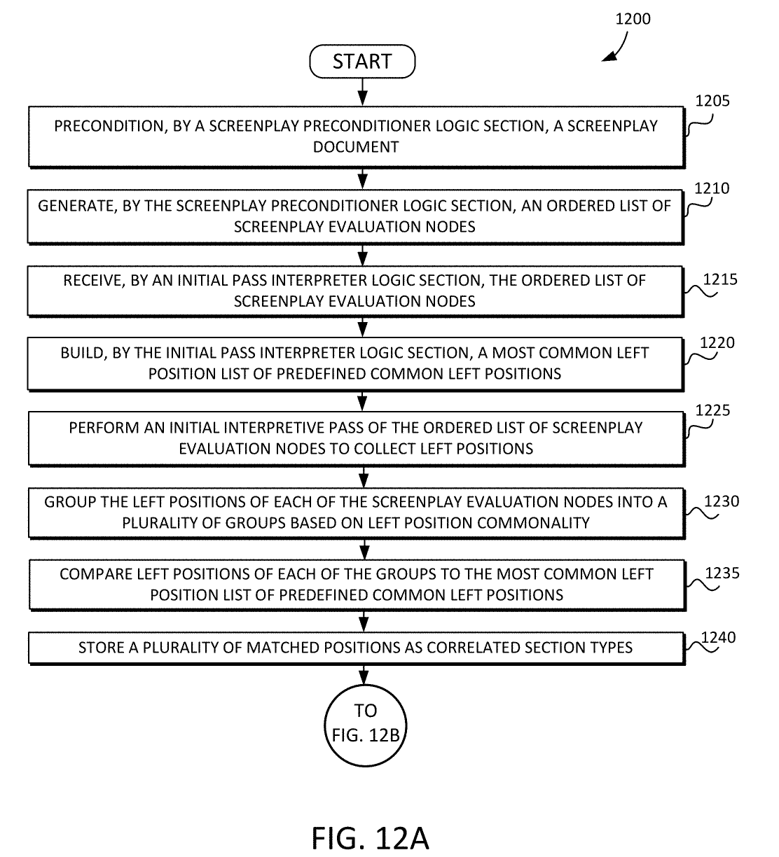

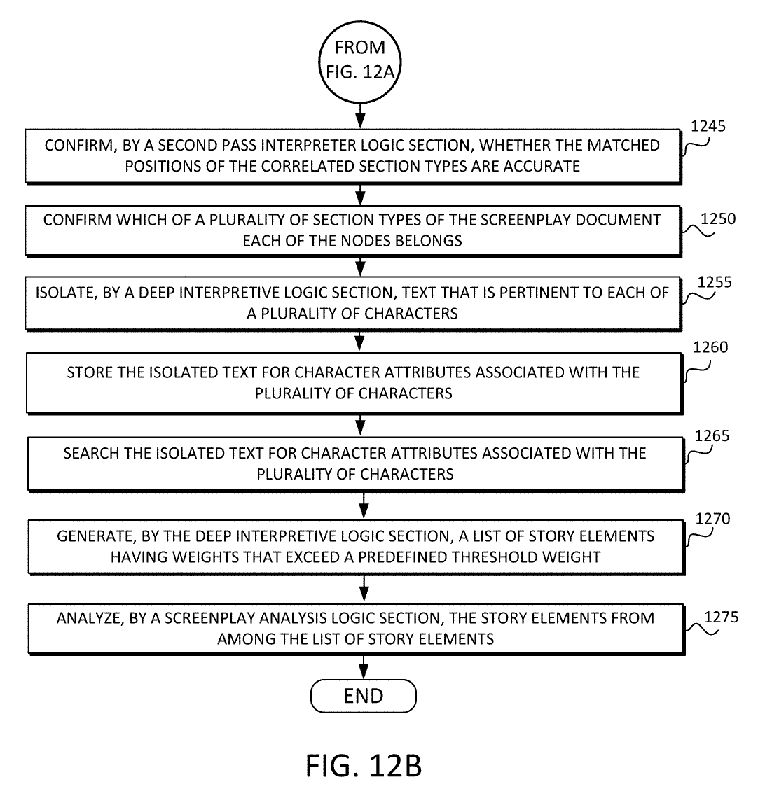

FIGS. 12A and 12B show a flow diagram 1200 illustrating a technique for analyzing a screenplay document in accordance with embodiments of the inventive concept. The technique can begin at 1205, where a screenplay preconditioner logic section can precondition the screenplay document by extracting and grouping textual information within the screenplay document. At 1210, the screenplay preconditioner logic section can generate an ordered list of screenplay evaluation nodes. At 1215, an initial pass interpreter logic section can receive the ordered list of screenplay evaluation nodes. At 1220, the initial pass interpreter logic section can build a most common left position list of predefined common left positions. At 1225, the initial pass interpreter logic section can perform an initial interpretive pass of the ordered list of screenplay evaluation nodes to collect left positions of each of the screenplay evaluation nodes of the screenplay document. At 1230, the initial pass interpreter logic section can group the left positions of each of the screenplay evaluation nodes into a plurality of groups based on left position commonality. At 1235, the initial pass interpreter logic section can compare left positions of each of the plurality of groups to the most common left position list of predefined common left positions. At 1240, the initial pass interpreter logic section can store a plurality of matched positions as correlated section types.

The flow can continue through the “TO FIG. 12B” circle. At 1245, a second pass interpreter logic section can confirm whether the matched positions of the correlated section types are accurate. At 1250, the second pass interpreter logic section can confirm which of a plurality of body section types of the screenplay document each of the nodes belongs, based at least on a width of each of the screenplay evaluation nodes being wider than a threshold width for each corresponding body section text type. At 1255, a deep interpretive logic section can isolate text that is pertinent to each of a plurality of characters. At 1260, the deep interpretive logic section can store the isolated text that is pertinent to each of the plurality of characters. At 1265, the deep interpretive logic section can search the isolated text for character attributes associated with the plurality of characters. At 1270, the deep interpretive logic section can generate a list of story elements. Each of the story elements in the list can have associated therewith a weight that exceeds a predefined threshold weight. At 1275, by a screenplay analysis logic section can analyze the story elements from among the list of story elements.

It will be understood that the steps shown in FIGS. 12A and 12B need not be performed in the order illustrated, but rather, can be performed in a different order, and/or with intervening steps.

Some embodiments include a screenplay content analysis engine. The screenplay content analysis engine can include a microprocessor, one or more storage devices coupled to the microprocessor, a user interface coupled to the microprocessor and configured to interface with one or more users, a receiver configured to receive a screenplay document, and one or more logic sections coupled to the microprocessor, the one or more logic sections being configured to receive the screenplay document from the receiver. The one or more logic sections and the microprocessor can be configured to interpret and analyze the screenplay document, and to produce summary information about the screenplay document. The one or more storage devices can be configured to store the summary information about the screenplay document. The user interface can be configured to display the summary information about the screenplay document on a display device for the one or more users.

In some embodiments, the one or more logic sections includes a screenplay preconditioner logic section configured to receive the screenplay document from the receiver, and to extract and group textual information within the screenplay document. The screenplay preconditioner logic section can include a text grouper logic section configured to pull the textual information from the screenplay document, and to organize the textual information into a plurality of relational blocks. The screenplay preconditioner logic section can further include a position parser logic section configured to determine position and dimension information of the textual information. The text grouper logic section and the position parser logic section can be configured to work in tandem to produce an ordered list of screenplay evaluation nodes based on the relational blocks and the position and dimension information.

In some embodiments, the screenplay preconditioner logic section further comprises a non-standard text filter logic section configured to clean any non-standard text from the relational blocks. In some embodiments, each of the relational blocks includes a page number of the screenplay document on which it appears. In some embodiments, each of the screenplay evaluation nodes includes a corresponding relational block from among the plurality of relational blocks. In some embodiments, each of the screenplay evaluation nodes further includes metadata information including the page number and the position and dimension information.

In some embodiments, the one or more logic sections includes an initial pass interpreter logic section configured to receive the ordered list of screenplay evaluation nodes from the screenplay preconditioner logic section. The initial pass interpreter logic section can be configured to build a most common left position list of predefined common left positions. The initial pass interpreter logic section can be configured to perform an initial interpretive pass of the ordered list of screenplay evaluation nodes to collect left positions of each of the screenplay evaluation nodes of the screenplay document.

In some embodiments, the initial pass interpreter logic section further includes a position correlator logic section configured to group the left positions of each of the screenplay evaluation nodes into a plurality of groups based on left position commonality. The position correlator logic section can be further configured to compare left positions of each of the plurality of groups to the most common left position list of predefined common left positions. The position correlator logic section can be further configured to store a plurality of matched positions as correlated section types.

In some embodiments, a first matched position from among the plurality of matched positions corresponds to a character in dialogue body section dialogue type, a second matched position from among the plurality of matched positions corresponds to a dialogue body section type, a third matched position from among the plurality of matched positions corresponds to a slug line body section type, a fourth matched position from among the plurality of matched positions corresponds to an action or description body section type, a fifth matched position from among the plurality of matched positions corresponds to a parenthetical body section type, a sixth matched position from among the plurality of matched positions corresponds to a camera direction body section type, a seventh matched position from among the plurality of matched positions corresponds to an ancillary body section text type, an eighth matched position from among the plurality of matched positions corresponds to a dual character in dialogue body section type, and a ninth matched position from among the plurality of matched positions corresponds to a dual dialogue body section type.

In some embodiments, the one or more logic sections further includes a second pass interpreter logic section configured to perform a second interpretive pass of the ordered list of screenplay evaluation nodes. The second pass interpreter logic section can include a type correlator logic section. The type correlator logic section can be configured to confirm whether the matched positions of the correlated section types are accurate, and to confirm which body section type of the screenplay document each of the nodes belongs, based at least on a width of each of the screenplay evaluation nodes being wider than a threshold width for each corresponding body section text type.

In some embodiments, the second pass interpreter logic section further includes a character name extractor logic section. The character name extractor logic section can be configured to capture character names and associated character dialogue in a character name and associated dialogue array.

In some embodiments, the second pass interpreter logic section further includes an array examination logic section. The array examination logic section can be configured to detect and merge any duplicate entries in the character name and associated dialogue array, and to count a number of words and a number of lines of dialogue for each of the character names.

In some embodiments, the one or more logic sections further includes a deep interpreter logic section configured to perform a deep interpretive pass of the ordered list of screenplay evaluation nodes. The deep interpreter logic section can be further configured to isolate text that is pertinent to each of a plurality of characters. The deep interpreter logic section can be further configured to store the isolated text that is pertinent to each of the plurality of characters.

In some embodiments, the deep interpreter logic section is further configured to search the isolated text for age-identifying text, and to associate any found age-identifying text to a particular character from among the plurality of characters. The deep interpreter logic section can be further configured to search the isolated text for gender-identifying text, and to associate any found gender-identifying text to a particular character from among the plurality of characters. The deep interpreter logic section can be further configured to search the isolated text for character attributes including at least one of race, nationality, or physical attributes, and to associate any found character attributes to a particular character from among the plurality of characters.

In some embodiments, the deep interpreter logic section is further configured to detect a plurality of story elements, wherein each story element corresponds to at least one of (a) an overarching theme of a story associated with the screenplay document, (b) an object of a story associated with the screenplay document, or (c) an action-based component of a story associated with the screenplay document. The deep interpreter logic section can be further configured to apply a weight to each of the story elements based at least on a number of matching terms associated with each of the story elements. The deep interpreter logic section can be further configured to generate a final list of story elements including only those story elements having a weight that exceeds a predefined threshold weight.

In some embodiments, the one or more logic sections further includes a screenplay analysis logic section configured to analyze the story elements from among the final list of story elements. The screenplay analysis logic section can be further configured to determine a genre for the screenplay document based at least on the story elements from among the final list of story elements.

In some embodiments, the screenplay analysis logic section is further configured to determine data points. The data points can include at least one of (a) a line count, (b) a page count, (c) a scene count, (d) an all word count, (e) an all unique word count, (f) an all advanced word count, (g) an action word count, (h) an action unique word count, (i) an action advanced word count, (j) a dialogue word count, (k) a dialogue unique word count, (l) a dialogue advanced word count, or (m) a number of characters.

In some embodiments, the screenplay analysis logic section is further configured to predict a content rating based on at least one of (a) the final list of story elements, (b) explicit dialogue, or (c) story elements not included in the final list of story elements.

The user interface can be further configured to display on the display device at least one of (a) a logline associated with the screenplay document, (b) a synopsis associated with the screenplay document, (c) a genre associated with the screenplay document, (d) characters associated with the screenplay document, (e) a budget level associated with the screenplay document, (f) a predicted content rating associated with the screenplay document, or (g) a dialogue to action ratio graph associated with the screenplay document.

Some embodiments can include a method for analyzing a screenplay document. The method can include preconditioning, by a screenplay preconditioner logic section, the screenplay document by extracting and grouping textual information within the screenplay document. The method can include generating, by the screenplay preconditioner logic section, an ordered list of screenplay evaluation nodes. The method can include receiving, by an initial pass interpreter logic section, the ordered list of screenplay evaluation nodes. The method can include building, by the initial pass interpreter logic section, a most common left position list of predefined common left positions. The method can include performing, by the initial pass interpreter logic section, an initial interpretive pass of the ordered list of screenplay evaluation nodes to collect left positions of each of the screenplay evaluation nodes of the screenplay document.

In some embodiments, the method can include grouping, by the initial pass interpreter logic section, the left positions of each of the screenplay evaluation nodes into a plurality of groups based on left position commonality. The method can include comparing, by the initial pass interpreter logic section, left positions of each of the plurality of groups to the most common left position list of predefined common left positions. The method can include storing, by the initial pass interpreter logic section, a plurality of matched positions as correlated section types.

In some embodiments, the method can include confirming, by a second pass interpreter logic section, whether the matched positions of the correlated section types are accurate. The method can include confirming, by the second pass interpreter logic section, which of a plurality of body section types of the screenplay document each of the nodes belongs, based at least on a width of each of the screenplay evaluation nodes being wider than a threshold width for each corresponding body section text type. The method can include isolating, by a deep interpretive logic section, text that is pertinent to each of a plurality of characters. The method can include storing, by the deep interpretive logic section, the isolated text that is pertinent to each of the plurality of characters. The method can include searching, by the deep interpretive logic section, the isolated text for character attributes associated with the plurality of characters. The method can include generating, by the deep interpretive logic section, a list of story elements, wherein each of the story elements in the list has associated therewith a weight that exceeds a predefined threshold weight. The method can include analyzing, by a screenplay analysis logic section, the story elements from among the list of story elements.

The following discussion is intended to provide a brief, general description of a suitable machine or machines in which certain aspects of the inventive concept can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the inventive concept can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the inventive concept with reference to illustrated embodiments, it will be recognized that the illustrated embodiments can be modified in arrangement and detail without departing from such principles, and can be combined in any desired manner And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the inventive concept to particular embodiment configurations. As used herein, these terms can reference the same or different embodiments that are combinable into other embodiments.

Embodiments of the invention may include a non-transitory machine-readable medium comprising instructions executable by one or more processors, the instructions comprising instructions to perform the elements of the embodiments as described herein.

Consequently, in view of the wide variety of permutations to the embodiments described herein, this detailed description and accompanying material is intended to be illustrative only, and should not be taken as limiting the scope of the inventive concept. What is claimed as the invention, therefore, is all such modifications as may come within the scope and spirit of the following claims and equivalents thereto.

1. A screenplay content analysis engine, comprising:
a microprocessor;
one or more storage devices coupled to the microprocessor;
a user interface coupled to the microprocessor and configured to interface with one or more users;
a receiver configured to receive a screenplay document; and
one or more logic sections coupled to the microprocessor, the one or more logic sections being configured to receive the screenplay document from the receiver,
wherein the one or more logic sections and the microprocessor are configured to interpret and analyze the screenplay document, and to produce summary information about the screenplay document,
wherein the one or more storage devices are configured to store the summary information about the screenplay document, and
wherein the user interface is configured to display the summary information about the screenplay document on a display device for the one or more users.

2. The screenplay content analysis engine of claim 1, wherein:
the one or more logic sections includes a screenplay preconditioner logic section configured to receive the screenplay document from the receiver, and to extract and group textual information within the screenplay document,
the screenplay preconditioner logic section includes a text grouper logic section configured to pull the textual information from the screenplay document, and to organize the textual information into a plurality of relational blocks,
the screenplay preconditioner logic section further includes a position parser logic section configured to determine position and dimension information of the textual information, and
the text grouper logic section and the position parser logic section are configured to work in tandem to produce an ordered list of screenplay evaluation nodes based on the relational blocks and the position and dimension information.

3. The screenplay content analysis engine of claim 2, wherein:
the screenplay preconditioner logic section further comprises a non-standard text filter logic section configured to clean any non-standard text from the relational blocks.

4. The screenplay content analysis engine of claim 2, wherein:
each of the relational blocks includes a page number of the screenplay document on which it appears,
each of the screenplay evaluation nodes includes a corresponding relational block from among the plurality of relational blocks, and
each of the screenplay evaluation nodes further includes metadata information including the page number and the position and dimension information.

5. The screenplay content analysis engine of claim 4, wherein:
the one or more logic sections includes an initial pass interpreter logic section configured to receive the ordered list of screenplay evaluation nodes from the screenplay preconditioner logic section,
the initial pass interpreter logic section is configured to build a most common left position list of predefined common left positions, and
the initial pass interpreter logic section is configured to perform an initial interpretive pass of the ordered list of screenplay evaluation nodes to collect left positions of each of the screenplay evaluation nodes of the screenplay document.

6. The screenplay content analysis engine of claim 5, wherein:
the initial pass interpreter logic section further includes a position correlator logic section configured to group the left positions of each of the screenplay evaluation nodes into a plurality of groups based on left position commonality,
the position correlator logic section is further configured to compare left positions of each of the plurality of groups to the most common left position list of predefined common left positions, and
the position correlator logic section is further configured to store a plurality of matched positions as correlated section types.

7. The screenplay content analysis engine of claim 6, wherein:
a first matched position from among the plurality of matched positions corresponds to a character in dialogue body section dialogue type,
a second matched position from among the plurality of matched positions corresponds to a dialogue body section type,
a third matched position from among the plurality of matched positions corresponds to a slug line body section type,
a fourth matched position from among the plurality of matched positions corresponds to an action or description body section type,
a fifth matched position from among the plurality of matched positions corresponds to a parenthetical body section type,
a sixth matched position from among the plurality of matched positions corresponds to a camera direction body section type,
a seventh matched position from among the plurality of matched positions corresponds to an ancillary body section text type,
an eighth matched position from among the plurality of matched positions corresponds to a dual character in dialogue body section type, and
a ninth matched position from among the plurality of matched positions corresponds to a dual dialogue body section type.

8. The screenplay content analysis engine of claim 5, wherein:
the one or more logic sections further includes a second pass interpreter logic section configured to perform a second interpretive pass of the ordered list of screenplay evaluation nodes,
the second pass interpreter logic section includes a type correlator logic section, and
the type correlator logic section is configured to confirm whether the matched positions of the correlated section types are accurate, and to confirm which body section type of the screenplay document each of the nodes belongs, based at least on a width of each of the screenplay evaluation nodes being wider than a threshold width for each corresponding body section text type.

9. The screenplay content analysis engine of claim 8, wherein:
the second pass interpreter logic section further includes a character name extractor logic section, and
the character name extractor logic section is configured to capture character names and associated character dialogue in a character name and associated dialogue array.

10. The screenplay content analysis engine of claim 9, wherein:
the second pass interpreter logic section further includes an array examination logic section, and
the array examination logic section is configured to detect and merge any duplicate entries in the character name and associated dialogue array, and to count a number of words and a number of lines of dialogue for each of the character names

11. The screenplay content analysis engine of claim 8, wherein:
the one or more logic sections further includes a deep interpreter logic section configured to perform a deep interpretive pass of the ordered list of screenplay evaluation nodes,
the deep interpreter logic section is further configured to isolate text that is pertinent to each of a plurality of characters, and
the deep interpreter logic section is further configured to store the isolated text that is pertinent to each of the plurality of characters.

12. The screenplay content analysis engine of claim 11, wherein:
the deep interpreter logic section is further configured to search the isolated text for age-identifying text, and to associate any found age-identifying text to a particular character from among the plurality of characters,
the deep interpreter logic section is further configured to search the isolated text for gender-identifying text, and to associate any found gender-identifying text to a particular character from among the plurality of characters, and
the deep interpreter logic section is further configured to search the isolated text for character attributes including at least one of race, nationality, or physical attributes, and to associate any found character attributes to a particular character from among the plurality of characters.

13. The screenplay content analysis engine of claim 11, wherein:
the deep interpreter logic section is further configured to detect a plurality of story elements, wherein each story element corresponds to at least one of (a) an overarching theme of a story associated with the screenplay document, (b) an object of a story associated with the screenplay document, or (c) an action-based component of a story associated with the screenplay document, and
the deep interpreter logic section is further configured to apply a weight to each of the story elements based at least on a number of matching terms associated with each of the story elements.

14. The screenplay content analysis engine of claim 13, wherein:
the deep interpreter logic section is further configured to generate a final list of story elements including only those story elements having a weight that exceeds a predefined threshold weight.

15. The screenplay content analysis engine of claim 14, wherein:
the one or more logic sections further includes a screenplay analysis logic section configured to analyze the story elements from among the final list of story elements, and
the screenplay analysis logic section is further configured to determine a genre for the screenplay document based at least on the story elements from among the final list of story elements.

16. The screenplay content analysis engine of claim 15, wherein:
the screenplay analysis logic section is further configured to determine data points,
wherein the data points include at least one of (a) a line count, (b) a page count, (c) a scene count, (d) an all word count, (e) an all unique word count, (f) an all advanced word count, (g) an action word count, (h) an action unique word count, (i) an action advanced word count, (j) a dialogue word count, (k) a dialogue unique word count, (l) a dialogue advanced word count, or (m) a number of characters.

17. The screenplay content analysis engine of claim 15, wherein:
the screenplay analysis logic section is further configured to predict a content rating based on at least one of (a) the final list of story elements, (b) explicit dialogue, or (c) story elements not included in the final list of story elements.

18. The screenplay content analysis engine of claim 1, wherein the user interface is further configured to display on the display device at least one of (a) one or more story elements associated with the screenplay document, (b) a logline associated with the screenplay document, (c) a synopsis associated with the screenplay document, (d) a genre associated with the screenplay document, (e) characters associated with the screenplay document, (f) a budget level associated with the screenplay document, (g) a predicted content rating associated with the screenplay document, or (h) a dialogue to action ratio graph associated with the screenplay document.

19. A method for analyzing a screenplay document, the method comprising:
preconditioning, by a screenplay preconditioner logic section, the screenplay document by extracting and grouping textual information within the screenplay document;
generating, by the screenplay preconditioner logic section, an ordered list of screenplay evaluation nodes;
receiving, by an initial pass interpreter logic section, the ordered list of screenplay evaluation nodes;
building, by the initial pass interpreter logic section, a most common left position list of predefined common left positions;
performing, by the initial pass interpreter logic section, an initial interpretive pass of the ordered list of screenplay evaluation nodes to collect left positions of each of the screenplay evaluation nodes of the screenplay document;
grouping, by the initial pass interpreter logic section, the left positions of each of the screenplay evaluation nodes into a plurality of groups based on left position commonality;
comparing, by the initial pass interpreter logic section, left positions of each of the plurality of groups to the most common left position list of predefined common left positions; and
storing, by the initial pass interpreter logic section, a plurality of matched positions as correlated section types.

20. The method of claim 19, further comprising:
confirming, by a second pass interpreter logic section, whether the matched positions of the correlated section types are accurate;
confirming, by the second pass interpreter logic section, which of a plurality of body section types of the screenplay document each of the nodes belongs, based at least on a width of each of the screenplay evaluation nodes being wider than a threshold width for each corresponding body section text type;
isolating, by a deep interpretive logic section, text that is pertinent to each of a plurality of characters;
storing, by the deep interpretive logic section, the isolated text that is pertinent to each of the plurality of characters;
searching, by the deep interpretive logic section, the isolated text for character attributes associated with the plurality of characters;
generating, by the deep interpretive logic section, a list of story elements, wherein each of the story elements in the list has associated therewith a weight that exceeds a predefined threshold weight; and
analyzing, by a screenplay analysis logic section, the story elements from among the list of story elements.
